(19) United States
(12) Patent Application Publication
(10) Pub. No.: US 2016/0174277 A1
(43) Pub. Date: Jun. 16, 2016

(54) METHOD OF CONNECTING WIRELESS NETWORK AND ELECTRONIC DEVICE THEREOF

(71) Applicant: Samsung Electronics Co., Ltd., Gyeonggi-do (KR)

(72) Inventors: Jung-Sik YOON, Gyeonggi-do (KR); Heang-Su KIM, lncheon (KR); Ha-Young CHOI, Gyeonggi-do (KR)

(21) Appl. No.: 14/959,249

(22) Filed: Dec. 4, 2015

(30) Foreign Application Priority Data
Dec. 12, 2014 (KR) 10-2014-0179479

(51) Int. Cl. H04W 76/02; H04W 4/00

(52) U.S. Cl. CPC H04W 76/023; H04W 4/008; H04W 84/12

(57) ABSTRACT

A method of operating an electronic device is provided. The method includes transmitting service connection information to another electronic device through a first communication connection, communicating, via a second communication connection, with the another electronic device based on the service connection information, and transmitting/receiving data corresponding to an Internet service and a screen sharing service of the another electronic device through the second communication connection.

### PRIORITY

This application claims priority under 35 U.S.C. §119(a) to Korean Patent Application Serial No. 10-2014-0179479, which was filed in the Korean Intellectual Property Office on Dec. 12, 2014, the entire content of which is incorporated herein by reference.

### BACKGROUND

1. Field of the Invention

The present disclosure relates generally to an apparatus and a method for connecting an electronic device to a wireless network, and more particularly, to an apparatus and a method for allowing an electronic device to transmit/receive data for an Internet service and a screen sharing service through connection with another electronic device.

2. Description of the Related Art

As information communication technologies and semiconductor technologies develop, various electronic devices have been developed as multimedia devices that provide various multimedia services.

Conventional electronic devices may provide a screen sharing service for sharing a screen displayed on a display with another electronic device. For example, the electronic device may transmit a screen displayed on a display thereof to another electronic device that is connected to the electronic device, so as to provide a mirroring service, which displays the corresponding screen on a display of the other electronic device. For example, the electronic device may be connected with another electronic device by using a short-range communication scheme (for example, Bluetooth®, WiFi®, or the like).

An electronic device, which is not able to access an Internet network, can use an Internet service through a tethering service using an Internet connection of another electronic device. However, a mirroring service of the electronic device cannot use the Internet communication connection through another electronic device, so that the electronic device cannot use the mirroring service and the tethering service with another electronic device at the same time. For example, a tablet (or a Personal Computer (PC)), which cannot access the Internet network, can provide access for the mirroring service with a smart phone, which can access the Internet network, by using a short-range communication scheme. However, the tablet cannot access the Internet network through the smart phone connected to the tablet through communication for the mirroring service.

### SUMMARY

The present disclosure has been made to address at least the above mentioned problems and/or disadvantages and to provide at least the advantages described below.

According to an aspect of the present disclosure, provides an apparatus and a method for allowing an electronic device to transmit/receive data for an Internet service and a screen sharing service through connection with another electronic device is provided.

According to an aspect of the present disclosure, an apparatus and a method for allowing an electronic device to transmit/receive data for an Internet service by using another electronic device connected to the electronic device through communication for a screen sharing service is provided.

In accordance with an aspect of the present disclosure, a method of operating an electronic device is provided. The method includes transmitting service connection information to another electronic device through a first communication connection, communicating, via a second communication connection, with the another electronic device based on the service connection information, and transmitting/receiving data corresponding to an Internet service and a screen sharing service of the another electronic device through the second communication connection.

In accordance with an aspect of the present disclosure, a method of operating an electronic device is provided. The method includes receiving service connection information from another electronic device through a first communication connection, communicating, via a second communication connection, with the another electronic device based on the service connection information, and transmitting/receiving data corresponding to an Internet service and a screen sharing service through the second communication connection.

In accordance with an aspect of the present disclosure, an electronic device is provided. The electronic device includes a communication interface configured to connect the electronic device with another electronic device by using a plurality of communication schemes and a processor configured to provide an Internet service and a screen sharing service to the another electronic device. The processor is configured to transmit service connection information to the another electronic device through a first communication connection, to communicate, via a second communication connection, with the another electronic device based on the service connection information, and to transmit/receive data corresponding to the an Internet service and the screen sharing service of the another electronic device through the second communication connection.

In accordance with an aspect of the present disclosure, an electronic device is provided. The electronic device includes a communication interface configured to connect the electronic device with another electronic device by using a plurality of communication schemes and a processor configured to provide an Internet service and a screen sharing service to the another electronic device. The processor is configured to receive service connection information from the another electronic device through a first communication connection with the another electronic device, to communicate, via a second communication connection, with the another electronic device based on the service connection information, and to transmit/receive data corresponding to the Internet service and the screen sharing service through the second communication connection.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram of an electronic device, according to an embodiment of the present disclosure;

FIG. 2 is a diagram of an electronic device, according to an embodiment of the present disclosure;

FIG. 3 is a diagram of a program module, according to an embodiment of the present disclosure;

FIG. 4 is a flowchart illustrating a method in which a first electronic device connects with a second electronic device for an Internet service, according to an embodiment of the present disclosure;

FIG. 5 is a flowchart illustrating a method in which a second electronic device provides an Internet service to a first electronic device, according to an embodiment of the present disclosure;

FIG. 6 is a signaling diagram illustrating a tethering connection using a Bluetooth®/BLE communication connection, according to an embodiment of the present disclosure;

FIGS. 7A-7E are screen configurations of a first electronic device having a tethering connection with a second electronic device by using a Bluetooth®/BLE communication connection, according to an embodiment of the present disclosure;

FIGS. 8A-8C are screen configurations of a second electronic device having a tethering connection with a first electronic device by using a Bluetooth®/BLE communication connection, according to an embodiment of the present disclosure;

FIG. 9 is a flowchart illustrating a method in which a first electronic device provides tethering by using a Bluetooth®/BLE communication connection, according to an embodiment of the present disclosure;

FIG. 10 is a flowchart illustrating a method in which a second electronic device provides tethering by using a Bluetooth®/BLE communication connection, according to an embodiment of the present disclosure;

FIG. 11 is a signaling diagram illustrating a tethering connection using a wireless LAN communication connection, according to an embodiment of the present disclosure;

FIGS. 12A-12D are screen configurations of a first electronic device having a tethering connection with a second electronic device by using a wireless LAN communication connection, according to an embodiment of the present disclosure;

FIG. 13 is a flowchart illustrating a method in which a first electronic device provides tethering by using a wireless LAN communication connection, according to an embodiment of the present disclosure;

FIG. 14 is a flowchart illustrating a method in which a second electronic device provides tethering by using a wireless LAN communication connection, according to an embodiment of the present disclosure;

FIG. 15 is a flowchart illustrating a method in which a first electronic device provides tethering by using a Bluetooth®/BLE communication connection with a second electronic device, according to an embodiment of the present disclosure;

FIG. 16 is a flowchart illustrating a method in which a second electronic device provides tethering by using a Bluetooth®/BLE communication connection with a first electronic device, according to an embodiment of the present disclosure;

FIG. 17 is a flowchart illustrating a method in which a first electronic device provides tethering by using a wireless LAN communication connection with a second electronic device, according to an embodiment of the present disclosure; and

FIG. 18 is a flowchart illustrating a method in which a second electronic device connects tethering by using a wireless LAN communication connection with a first electronic device, according to an embodiment of the present disclosure.

### DETAILED DESCRIPTION

Hereinafter, various embodiments of the present disclosure will be described with reference to the accompanying drawings. In the following description, specific details such as detailed configuration and components are merely provided to assist in the overall understanding of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be referred to as a second element without departing from the scope of right of various embodiments of the present disclosure, and similarly, a second element may be referred to as a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a central processing unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The term “module” as used herein may, for example, is defined as a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

The module or program module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

In accordance with the present disclosure, an electronic device may include, but is not limited to, at least one of a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), electronic glasses, electronic clothing, an electronic bracelet, an electronic necklace, an electronic appcessory, an electronic tattoo, a smart mirror, or a smart watch).

The electronic device may be a smart home appliance. For example, the smart home appliance may include, but is not limited to, at least one of a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV®); a game console (e.g., Xbox® PlayStation®); an electronic dictionary; an electronic key; a camcorder; or an electronic frame.

The electronic device may include at least one of medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; electronic equipment for a ship (e.g., ship navigation equipment and/or a gyrocompass); avionics equipment; security equipment; a head unit for vehicle; an industrial or home robot; an automatic teller's machine (ATM) of a financial institution, point of sale (POS) device at a retail store, or an internet of things device (e.g., a light bulb, various sensors, an electronic meter, a gas meter, a sprinkler, a fire alarm, a thermostat, a streetlamp, a toaster, a sporting equipment, a hot-water tank, a heater, or a boiler and the like).

The electronic device may include at least one of a piece of furniture or a building/structure; an electronic board; an electronic signature receiving device; a projector; and various measuring instruments (e.g., a water meter, an electricity meter, a gas meter, or a wave meter).

The electronic device may also include a combination of one or more of the above-mentioned devices.

Further, it will be apparent to those skilled in the art that the electronic device is not limited to the above-mentioned devices.

Herein, the term “user” may indicate a person who uses an electronic device or a device (e.g., an artificial intelligence electronic device) that uses the electronic device.

Hereinafter, various embodiments of the present disclosure describe a technology for allowing an electronic device to provide communication for an Internet service (for example, tethering). The tethering may include a mobile hotspot function by which a device can access an Internet network by using another device, which can access the Internet network. Hereinafter, the present disclosure will be described based on an assumption that communication for the tethering is provided using a wireless LAN communication scheme (for example, WiFi®). However, the present disclosure can be applied to a case where the communication for the tethering is connected using another communication scheme.

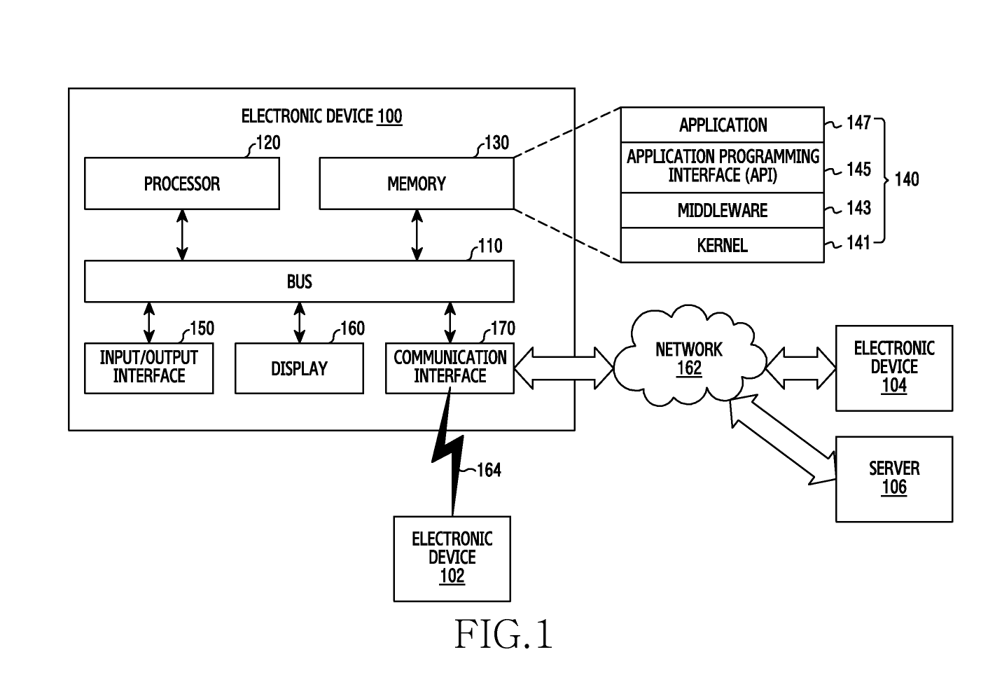

FIG. 1 is a diagram of an electronic device 100, according to an embodiment of the present disclosure.

Referring to FIG. 1, the electronic device 100 includes a bus 110, a processor 120, a memory 130, an input/output interface 150, a display 160, and a communication interface 170. At least one of the components of the electronic device 100 may be omitted, or other components may be additionally included in the electronic device 100.

The bus 110 may be a circuit that connects the processor 120, the memory 130, the input/output interface 150, the display 160, or the communication interface 170 to one another and transmits data (for example, control messages) between the above described components.

The processor 120 may include one or more of a Central Processing Unit (CPU), an Application Processor (AP), and a Communication Processor (CP). For example, the processor 120 may carry out operations or data processing related to control and/or communication of at least one other component of the electronic device 100.

The processor 120 controls to provide a second communication connection for an Internet service with another electronic device 102 by using a first communication connection for a screen sharing service (for example, a mirroring service) with the electronic device 102. The processor 120 provides the screen sharing service and the Internet service with the electronic device 102 by using the second communication connection. For example, the first communication connection may include a communication connection using at least one communication scheme of Bluetooth®, Bluetooth® Low Energy (BLE), WiFi® direct, and WiFi® AP. The WiFi® AP may refer to a communication scheme through which the electronic device 100 connects with another electronic device by using an Access Point (AP). For example, the second communication connection may include a communication connection for tethering.

The processor 120 receives service connection information from the electronic device 102 by using the first communication connection for the screen sharing service. The processor 120 provides the second communication connection to the electronic device 102 by using the service connection information. The processor 120 provides the Internet service and the screen sharing service to the electronic device 102 by using the second communication connection. For example, the service connection information may include information for the second communication connection (for example, an identifier of another electronic device (Service Set Identifier: SSID) and an access password) and access information on the screen sharing service (for example, a MAC address or an IP address).

When a tethering connection event is generated based on input information detected through the input/output interface 150, the processor 120 transmits a tethering connection request service to the electronic device 102 through the first communication connection. The processor 120 receives service connection information from the electronic device 102 through the first communication connection in response to the tethering connection request signal. The processor 120 provides the second communication connection to the electronic device 102 using information for the second communication connection included in service provision information. The processor 120 provides the screen sharing service to the electronic device 102 using the access information on the screen sharing service included in the service provision information. The processor 120 provides the Internet service and the screen sharing service to the electronic device 102 through the second communication connection.

The processor 120 transmits the service connection information to the electronic device 102 using the first communication connection for the screen sharing service. The processor 120 provides the second communication to the electronic device 102 using the service connection information. The processor 120 provides the Internet service to the electronic device 102 using the second communication connection and provides the screen sharing service to the electronic device 102.

The processor 120 receives a tethering connection request signal from the electronic device 102 through the first communication connection. The processor 120 transmits service connection information to the electronic device 102 through the first communication connection in response to the tethering connection request signal. The processor 120 provides the second communication to the electronic device 102 using information for the second communication connection included in service provision information. The processor 120 connects the screen sharing service with the electronic device 102 using the access information on the screen may provides the Internet service to the electronic device 102 through the second communication connection and provides the screen sharing service with the electronic device 102.

When the second communication is provided to the electronic device 102, the processor 120 releases the first communication connection from the electronic device 102.

When the second communication is provided to the electronic device 102, the processor 120 transmits/receives a control signal for the second communication connection using the first communication connection.

The processor 120 identifies whether the electronic device 102 supports tethering based on tethering state information provided from the electronic device 102. For example, the tethering state information may include mobile network accessible information and mobile data use menu set configuration of the electronic device 102.

The memory 130 may include a volatile memory and/or a non-volatile memory. The memory 130 stores, for example, instructions or data relevant to at least one other element of the electronic device 100. The memory 130 stores software and/or a program 140. The program 140 includes, for example, a kernel 141, middleware 143, an Application Programming Interface (API) 145, and/or application programs (or applications) 147. At least some of the kernel 141, the middleware 143, and the API 145 may be referred to as an Operating System (OS).

The kernel 141 controls and/or manages system resources (e.g., the bus 110, the processor 120, or the memory 130) used for performing an operation or function implemented by the other programs (e.g., the middleware 143, the API 145, or the application programs 147). Furthermore, the kernel 141 provides an interface through which the middleware 143, the API 145, or the application programs 147 may access the individual elements of the electronic device 100 to control or manage the system resources.

The middleware 143, for example, may function as an intermediary for allowing the API 145 or the application programs 147 to communicate with the kernel 141 to exchange data.

In addition, the middleware 143 processes one or more task requests received from the application programs 147 according to priorities thereof. For example, the middleware 143 assigns priorities for using the system resources (e.g., the bus 110, the processor 120, the memory 130, or the like) of the electronic device 100, to at least one of the application programs 147. For example, the middleware 143 performs scheduling and/or loading balancing on the one or more task requests by processing the one or more task requests according to the priorities assigned thereto.

The API 145 is an interface through which the applications 147 control functions provided from the kernel 141 and/or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 100. Furthermore, the input/output interface 150 may output the instructions or data received from the other element(s) of the electronic device 100 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The display 160 displays information on whether the electronic device 102 supports tethering. For example, when the electronic device 102 supports the tethering, the display 160 displays a tethering supporting icon for the electronic device 102. For example, when the electronic device 102 supports the tethering, the display 160 displays tethering state information on the electronic device 102 in a widget for the screen sharing service.

The communication interface 170, for example, provides communication between the electronic device 100 and an external device (e.g., the first external electronic device 102, a second external electronic device 104, or a server 106). For example, the communication interface 170 may be connected to a network 162 through wireless or wired connection to provide communication between the electronic device 100 and the external device 104 or the server 106.

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may use, for example, short range communication 164. The short-range communication 164 may include at least one of, for example, WiFi®, Bluetooth®, Near Field Communication (NFC), and Global Positioning System (GPS).

The wired communication may use at least one of, for example, a Universal Serial Bus (USB), a High Definition Multimedia Interface (HDMI), Recommended Standard-232 (RS-232), and a Plain Old Telephone Service (POTS).

The network 162 may include at least one of a communication network such as a computer network (e.g., a LAN or a WAN), the Internet, and a telephone network.

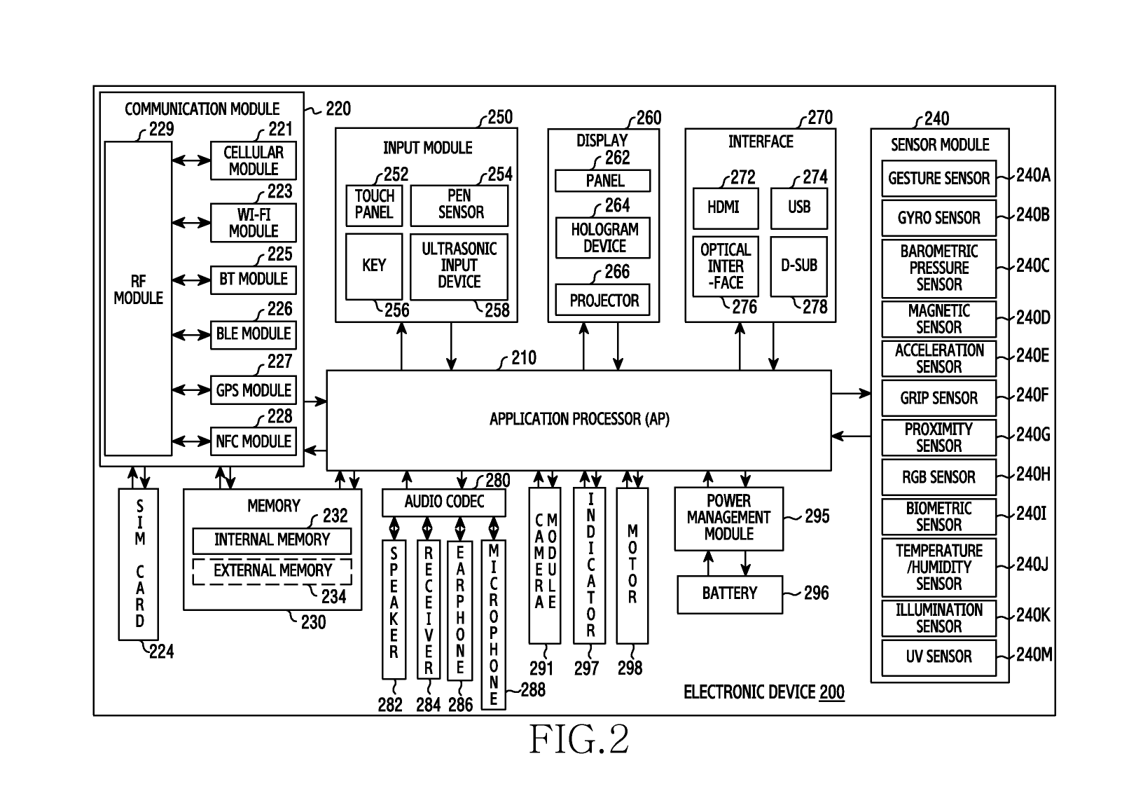

FIG. 2 is a diagram illustrating an electronic device 200, according to an embodiment of the present disclosure. The electronic device 200 may include all or some of the components of the electronic device 100 illustrated in FIG. 1. The electronic device 200 includes one or more processors (e.g., AP 210), a communication module 220, a Subscriber Identity Module (SIM) card 224, a memory 230, a sensor module 240, an input device 250, a display 260, an interface 270, an audio module 280, a camera module 291, a power management module 295, a battery 296, an indicator 297, and a motor 298.

The processor 210 drives, for example, an OS or an application program to control a plurality of hardware or software components connected to the processor 210 and to perform a variety of data processing and operations. The processor 210 may be implemented in a System on Chip (SoC). The processor 210 may further include a Graphic Processing Unit (GPU) and/or an image signal processor.

The communication module 220 (e.g., the communication interface 170) performs data transmission/reception in communication between the electronic device 200 (e.g., the electronic device 100) and other electronic devices (e.g., the electronic device 102 or the server 104) connected via a network (e.g., the network 162). The communication module 220 includes a cellular module 221, a Wi-Fi® module 223, a BT® module 225, a GPS module 227, an NFC module 228, and a Radio Frequency (RF) module 229.

The cellular module 221 provides voice communication, image communication, a short message service, or an Internet service, etc. via a communication network (e.g., LTE, LTE-A, CDMA, WCDMA, UMTS, WiBro, GSM, etc.). Also, the cellular module 221 performs discrimination and authentication of an electronic device within a communication network using, for example, the SIM card 224. The cellular module 221 performs at least a portion of functions that may be provided by the processor 210. For example, the cellular module 221 performs at least a portion of a multimedia control function.

The cellular module 221 includes a Communication Processor (CP). Also, the cellular module 221 may be, for example, implemented as an SoC. Though elements such as the cellular module 221 (e.g., a CP), the memory 230, or the power management module 295, etc. are illustrated as elements separated from the processor 210 in FIG. 2, the processor 210 may be configured to include at least a portion (e.g., the cellular module 221) of the above-described elements.

The processor 210 or the cellular module 221 may provide a second communication connection for an Internet service to another electronic device (e.g., another electronic device 102 of FIG. 1) by using a first communication connection for a screen sharing service (for example, a mirroring service) with the electronic device 102. The processor 120 or the cellular module 221 provides the screen sharing service and the Internet service to the electronic device 102 using the second communication connection.

The processor 210 or the cellular module 221 may load an instruction and/or data received from at least one of a non-volatile memory and other elements connected thereto onto a volatile memory, and process the same. Also, the processor 210 or the cellular module 221 stores data received from at least one of other elements or generated by at least one of other elements in a non-volatile memory.

Each of the Wi-Fi® module 223, the BT® module 225, the GPS module 227, or the NFC module 228 may include, for example, a processor for processing data transmitted/received via a relevant module. Though the cellular module 221, the Wi-Fi® module 223, the BT® module 225, the GPS module 227, or the NFC module 228 are illustrated as separate blocks in FIG. 2, at least a portion (e.g., two or more elements) of the cellular module 221, the Wi-Fi® module 223, the BT® module 225, the GPS module 227, or the NFC module 228 may be included on one Integrated Circuit (IC) or an IC package. For example, at least a portion (e.g., a communication processor corresponding to the cellular module 221 and a Wi-Fi® processor corresponding to the Wi-Fi® module 223) of processors corresponding to each of the cellular module 221, the Wi-Fi® module 223, the BT® module 225, the GPS module 227, or the NFC module 228 may be implemented as one SoC.

The RF module 229 performs transmission/reception of data, for example, transmission/reception of an RF signal. The RF module 229 may include, for example, a transceiver, a Power Amp Module (PAM), a frequency filter, or a Low Noise Amplifier (LNA), etc. Also, the RF module 229 may further include a part for transmitting/receiving an electromagnetic wave in free space in wireless communication, for example, a conductor or a conducting line, etc. Though FIG. 2 illustrates the cellular module 221, the Wi-Fi® module 223, the BT® module 225, the GPS module 227, and the NFC module 228 share one RF module 229, at least one of the cellular module 221, the Wi-Fi® module 223, the BT® module 225, the GPS module 227, or the NFC module 228 may perform transmission/reception of an RF signal via a separate RF module.

The SIM card 224 may be inserted into a slot formed in a specific position of the electronic device 200. The SIM card 224 may include unique identify information (e.g., Integrated Circuit Card Identifier (ICCID)) or subscriber information (e.g., International Mobile Subscriber Identity (IMSI)).

The memory 230 (e.g., the memory 130) includes a built-in (internal) memory 232 or an external memory 234. The built-in memory 232 may include, for example, at least one of a volatile memory (e.g., Dynamic RAM (DRAM), Static RAM (SRAM), Synchronous Dynamic RAM (SDRAM)) and a non-volatile memory (e.g., One Time programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

The built-in memory 232 may be a Solid State Drive (SSD). The external memory 234 may further include a flash drive, for example, Compact Flash (CF), Secure digital (SD), Micro Secure Digital (Micro-SD), Mini Secure Digital (Mini-SD), extreme Digital (xD), or a memory stick. The external memory 234 may be functionally connected with the electronic device 200 via various interfaces. The electronic device 200 may further include a storage device (or a storage medium) such as a hard drive.

The sensor module 240 measures a physical quantity or detects an operational state of the electronic device 200, and converts the measured or detected information to an electric signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., Red, Green, Blue (RGB) sensor), a living body sensor 240I, a temperature/humidity sensor 240J, an illumination sensor 240K, or an Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, or a fingerprint sensor, etc. The sensor module 240 may further include a control circuit for controlling at least one of the aforementioned sensors.

The input unit 250 includes a touch panel 252, a (digital) pen sensor 254, a key 256, or an ultrasonic input unit 258. The touch panel 252 recognizes a touch input using at least one of capacitive, resistive, infrared, or ultrasonic methods. Also, the touch panel 252 may further include a control circuit. A capacitive touch panel may perform detection by a physical contact or proximity recognition. The touch panel 252 may further include a tactile layer. In this case, the touch panel 252 may provide a tactile reaction to a user.

The (digital) pen sensor 254 may be implemented using, for example, a method which is the same as or similar to receiving a user's touch input, or using a separate sheet for detection. The key 256 includes, for example, a physical button, an optical key or keypad. The ultrasonic input unit 258 is a unit for recognizing data by detecting a sound wave using a microphone 288 in the electronic device 200, via an input tool generating an ultrasonic signal, and enables wireless recognition. The electronic device 200 may receive a user input from an external device (e.g., a computer or a server) connected to the communication module 220 using the communication module 220.

The display 260 includes a panel 262, a hologram device 264, or a projector 266. The panel 262 may be, for example, an LCD, or an Active-Matrix Organic Light-Emitting Diode (AM-OLED), etc. The panel 262 may be implemented, for example, such that it is flexible, transparent, or wearable. The panel 262 may be configured as one module together with the touch panel 252. The hologram device 264 may project a three-dimensional image in the air using interferences of light. The projector 266 may project light onto a screen to display an image. The screen may be positioned, for example, inside or outside the electronic device 200. The display 260 may further include a control circuit for controlling the panel 262, the hologram device 264, and/or the projector 266.

The interface 270 may include, for example, an HDMI 272, a USB 274, an optical interface 276, or a D-subminiature (D-sub) 278. The interface 270 may be included, for example, in the communication interface 170 illustrated in FIG. 1. Additionally or alternatively, the interface 270 may include, for example, a Mobile High-Definition Link (MHL) interface, a Secure Digital (SD) card/Multi-Media Card (MMC) interface, or an Infrared Data Association (IrDA) standard interface.

The audio module 280 converts a sound and an electric signal in dual directions. At least a partial element of the audio module 280 may be included, for example, in the I/O interface 150 illustrated in FIG. 1. The audio module 280 processes sound information input or output via, for example, a speaker 282, a receiver 284, an earphone 286, or a microphone 288, etc.

The camera module 291 is a device that may capture a still image and a moving picture. The camera module 291 may include one or more image sensors (e.g., a front sensor or a rear sensor), a lens, an Image Signal Processor (ISP), or a flash (e.g., an LED or xenon lamp).

The power management module 295 manages power of the electronic device 200. The power management module 295 may include, for example, a Power Management Integrated Circuit (PMIC), a charger IC, a battery, or a battery or fuel gauge.

The PMIC may be mounted, for example, inside an integrated circuit or an SoC semiconductor. A charging method may include a wired charging method and a wireless charging method. The charging IC may charge a battery and prevent introduction of an overvoltage or an overcurrent from a charger. The charging IC may include a charging IC for at least one of the wired charging method and the wireless charging method. The wireless charging method may be, for example, a magnetic resonance method, a magnetic induction method, or an electromagnetic wave method, etc., and may additionally include an additional circuit for wireless charging, for example, a circuit such as a coil loop, a resonance circuit, or a rectifier, etc.

The battery gauge measures, for example, a charge of the battery 296, a voltage, a current, or a temperature while charging. The battery 296 stores or generates electricity, and supplies power to the electronic device 200 using the stored or generated electricity. The battery 296 may include, for example, a rechargeable battery or a solar battery.

The indicator 297 displays a specific state of the electronic device 200 or a portion thereof (e.g., the processor 210), for example, a booting state, a message state, or a charging state, etc. The motor 298 converts an electric signal to mechanical vibration. The electronic device 200 may include a processor (e.g., a GPU) for supporting a mobile TV. The processor for supporting the mobile TV may process media data corresponding to standards, for example, such as Digital Multimedia Broadcasting (DMB), Digital Video Broadcasting (DVB), or a media flow, etc.

Each of the above-described component elements of hardware may be configured with one or more components, and the names of the corresponding component elements may vary based on the type of electronic device. The electronic device 200 may include at least one of the aforementioned elements. Some elements may be omitted or other additional elements may be further included in the electronic device 200. Also, some of the hardware components may be combined into one entity, which may perform functions identical to those of the relevant components before the combination.

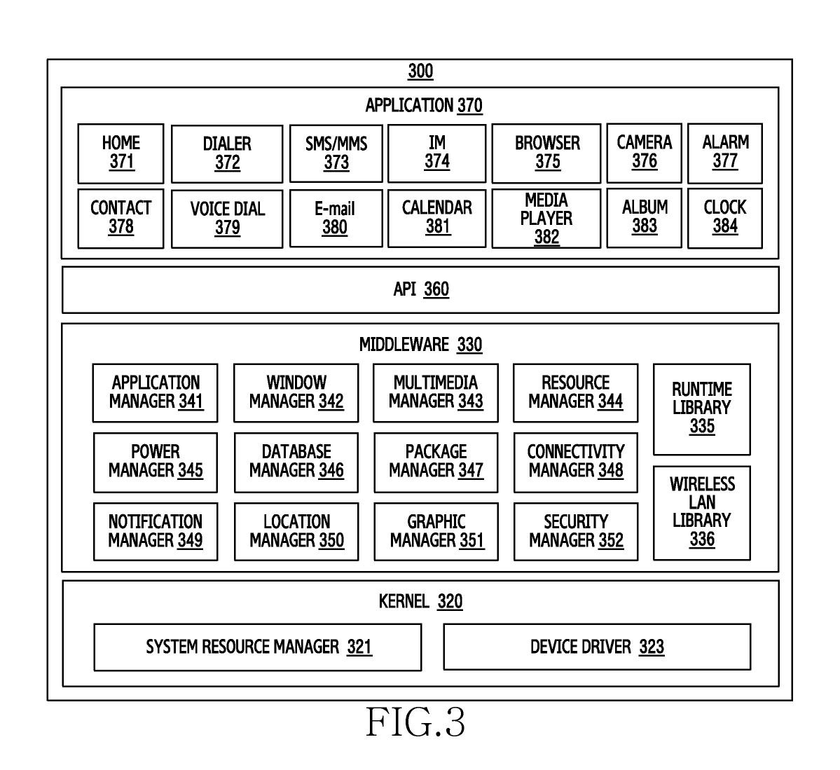

FIG. 3 is a block diagram of a program module 300, according to an embodiment of the present disclosure.

The program module 300 (for example, the programs 140) may include an OS for controlling resources related to the electronic device 100 or 200 and/or various applications (for example, the application programs 147) executed in the OS. The OS may be, for example, Android®, iOS®, Windows®, Symbian®, Tizen®, Bada®, or the like.

The program module 300 includes a kernel 320, middleware 330, an API 360, and/or applications 370. At least some of the program module 300 may be preloaded in the electronic device or downloaded from the server 106.

The kernel 320 (for example, the kernel 141 of FIG. 1) may include, for example, a system resource manager 331 or a device driver 333. The system resource manager 331 controls, allocates, or collects the system resources. The system resource manager 331 may include a process management unit, a memory management unit, or a file system management unit. The device driver 333 may include, for example, a display driver, a camera driver, a Bluetooth® driver, a shared-memory driver, a USB driver, a keypad driver, a WiFi® driver, an audio driver, or an Inter-Process Communication (IPC) driver.

The middleware 330 provides a function required by the applications 370 in common or provide various functions to the applications 370 through the API 360 so that the applications 370 can efficiently use limited system resources within the electronic device. The middleware 330 may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses to add new functions through a programming language while the application 370 is executed. The runtime library 335 performs input/output management, memory management, or a function for an arithmetic function.

The application manager 341 manages, for example, a life cycle of at least one of the applications 370. The window manager 342 manages Graphical User Interface (GUI) resources used by a screen. The multimedia manager 343 obtains formats required for the reproduction of various media files, and performs an encoding or decoding of the media file by using a codec suitable for the corresponding format. The resource manager 344 manages resources such as a source code, a memory, and a storage space of at least one of the applications 370.

The power manager 345 operates together with a Basic Input/Output System (BIOS) to manage a battery or power and provides power information required for the operation of the electronic device. The database manager 346 generates, searches for, or changes a database to be used by at least one of the applications 370. The package manager 347 manages the installation or the updating of applications distributed in the form of package file.

The connectivity manager 348 manages wireless connection of, for example, Wi-Fi® or Bluetooth®. The notification manager 349 displays or notifies of an event such as an arrival message, proximity notification, and the like in such a way that does not disturb a user. The location manager 350 manages location information of the electronic device. The graphic manager 351 manages graphic effects to be provided to a user and user interfaces related to the graphic effects. The security manager 352 may provide all security functions required for system security or user authentication. When the electronic device (for example, electronic device 100) has a call function, the middleware 330 may further include a telephony manager for managing a voice call function or a video call function of the electronic device.

The middleware 330 may include a middleware module for forming a combination of various functions of the aforementioned components. The middleware 330 provides modules specialized according to types of operating systems in order to provide differentiated functions. Further, the middleware 330 dynamically removes some of the existing components or add new components.

The API 360 is, for example, a set of API programming functions, and a different configuration thereof may be provided according to an operating system provided in the electronic device. For example, Android® or iOS® may provide one API set per platform, and Tizen® may provide two or more API sets per platform.

The applications 370 may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to various embodiments of the present disclosure, an electronic device may include: a communication interface for connecting the electronic device with a counterpart electronic device by using a plurality of communication schemes; and a processor for making a control to provide an Internet service and a screen sharing service with the counterpart electronic device, wherein the processor may make a control to transmit service connection information to the counterpart electronic device through first communication with the counterpart electronic device, to connect second communication with the counterpart electronic device based on the service connection information, and to transmit/receive data corresponding to an Internet service and the screen sharing service of the counterpart electronic device through the second communication.

According to various embodiments, the first communication may include at least one of Bluetooth, Bluetooth Low Energy (BLE), WiFi direct, and WiFi Access Point (AP).

According to various embodiments, the second communication may include a communication scheme for a tethering service.

According to various embodiments, the communication scheme for the tethering service may include a wireless LAN.

According to various embodiments, the service connection information may include information for the second communication connection and access information on the screen sharing service.

According to various embodiments, the processor may make a control to release the first communication connection with the counterpart electronic device when the first communication is a wireless LAN, and to connect the second communication with the counterpart electronic device by using the service connection information.

According to various embodiments, the processor may make a control to generate a channel of the second communication for the screen sharing service with the counterpart electronic device based on the service request information and to transmit/receive data corresponding to the Internet service and the screen sharing service of the counterpart electronic device through the channel.

According to various embodiments, the processor may make a control to transmit second communication scheme supporting information to the counterpart electronic device through the first communication, and to transmit service connection information to the counterpart electronic device through the first communication when a second communication connection request signal is received from the counterpart electronic device.

According to various embodiments, the processor may determine the second communication scheme supporting information of the counterpart electronic device based on whether the electronic device supports a mobile network and mobile data transmission/reception set menu information of the electronic device.

According to various embodiments of the present disclosure, an electronic device may include: a communication interface for connecting the electronic device with a counterpart electronic device by using a plurality of communication schemes; and a processor for making a control to provide an Internet service and a screen sharing service with the counterpart electronic device, wherein the processor may make a control to receive service connection information from the counterpart electronic device through first communication with the counterpart electronic device, to connect second communication with the counterpart electronic device based on the service connection information, and to transmit/receive data corresponding to the Internet service and the screen sharing service through the second communication.

According to various embodiments, the first communication may include at least one of Bluetooth, Bluetooth Low Energy (BLE), WiFi direct, and WiFi Access Point (AP).

According to various embodiments, the second communication may include a communication scheme for a tethering service.

According to various embodiments, the communication scheme for the tethering service may include a wireless LAN.

According to various embodiments, the service connection information may include information for the second communication connection and access information on the screen sharing service.

According to various embodiments, the processor may make a control to release the first communication connection with the counterpart electronic device when the first communication is a wireless LAN, and to connect the second communication with the counterpart electronic device by using the service connection information.

According to various embodiments, the processor may make a control to generate a channel of the second communication for the screen sharing service with the counterpart electronic device based on the service request information and to transmit/receive data corresponding to the Internet service and the screen sharing service through the channel.

According to various embodiments, the electronic device may further include a display for displaying information, and the processor may make a control to receive resource information on a second communication scheme from the counterpart electronic device through the first communication and to display the resource information on the second communication scheme of the counterpart electronic device on the display.

According to various embodiments, the electronic device may further include an input/output interface, and the processor may make a control to detect input information on the resource information on the second communication scheme displayed on the display and to transmit a second communication connection request signal to the counterpart electronic device through the first communication in response to the input information.

Hereinafter, the first electronic device may be an electronic device, which makes a communication connection request for the Internet service. The second electronic device may be an electronic device, which provides communication connection for the Internet service for the first electronic device in response to the communication connection request being received from the first electronic device. However, one electronic device may operate as the first electronic device or the second electronic device according to the existence of the communication connection request.

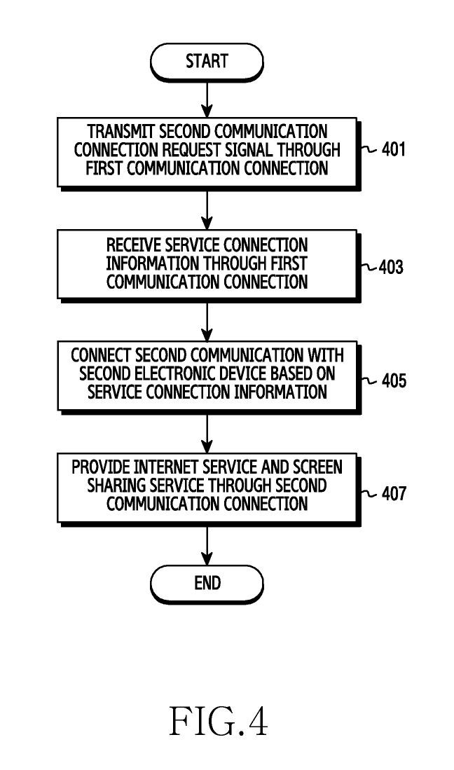

FIG. 4 is a flowchart illustrating a method in which a first electronic device connects with a second electronic device for the Internet service, according to an embodiment of the present disclosure.

Referring to FIG. 4, in operation 401, the first electronic device (for example, the electronic device 100 of FIG. 1) transmits a connection request signal to the second electronic device (for example, the electronic device 102 of FIG. 1) by using a first communication connection. For example, when a tethering connection event is generated based on input information detected through the input/output interface 150, the first electronic device transmits a tethering connection request signal through the first communication connection to the second electronic device. For example, the first communication connection may include a communication connection using at least one communication scheme of Bluetooth®, BLE WiFi® direct, and WiFi® AP. The second communication connection may include a communication connection using tethering.

In operation 403, the first electronic device receives service connection information from the second electronic device through the first communication connection. For example, the service connection information may include information for the second communication connection (for example, an identifier of the second electronic device (SSID) and an access password) and access information on the screen sharing service (for example, a MAC address or an IP address).

In operation 405, the first electronic device connects with the second electronic device using information for the second communication connection included in the service connection information. For example, the first electronic device accesses the second electronic device operating as an AP for the tethering service by using the information for the second communication connection.

In operation 407, the first electronic device is provided with the Internet service and the screen sharing service using the second communication connection. For example, the first electronic device accesses the Internet network through the second electronic device using the second communication connection and transmits/receives data for the screen sharing service to/from the second electronic device.

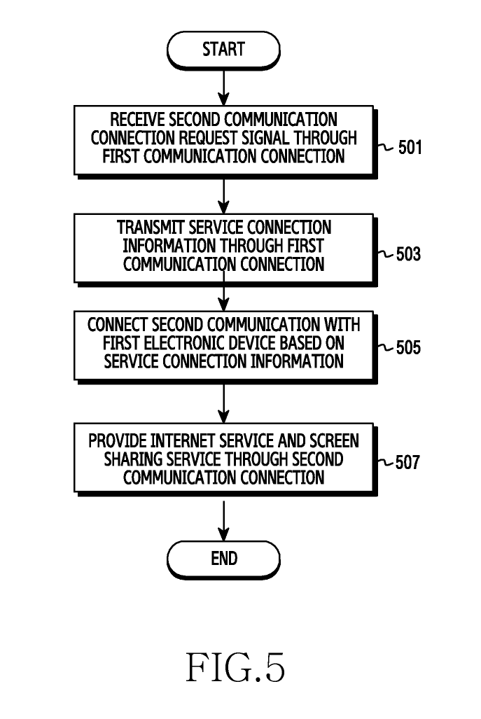

FIG. 5 is a flowchart illustrating a method in which the second electronic device provides an Internet service to the first electronic device, according to an embodiment of the present disclosure.

Referring to FIG. 5, in operation 501, the second electronic device (for example, the electronic device 100 of FIG. 1) receives a connection request signal using a first communication connection with the first electronic device (for example, the electronic device 102 of FIG. 1). For example, the second electronic device receives a connection request signal for tethering from the first electronic device through the first communication connection.

In operation 503, the second electronic device transmits service connection information to the first electronic device through the first communication connection in response to the connection request signal. For example, the second electronic device encrypts the service connection information through a Data Encryption Standard (DES) scheme and transmits the encrypted service connection information to the first electronic device.

In operation 505, the second electronic device connects with the first electronic device using information for the second communication connection included in the service connection information. For example, the second electronic device operates as an AP for the tethering service using the information for the second communication connection. The second electronic device connects the communication for the tethering service with the first electronic device in response to the access request signal received from the first electronic device.

In operation 507, the second electronic device is provided with the Internet service and the screen sharing service using the second communication connection. For example, the second electronic device transmits/receives data for the Internet service to/from the first electronic device by using the second communication connection and transmits/receives data for the screen sharing service with the first electronic device. For example, the data for the screen sharing service may include at least one piece of screen sharing information, keyboard/mouse input information, call reception information (for example, phone information received by the second electronic device), clipboard information, and notification generation information. The screen sharing information may include at least one piece of touch input information (for example, a touch, a drag, and a pinch) and screen information displayed on the display 160. The clipboard information may include data such as text for a clipboard service. The notification generation information may include notification event generation information such as a missed call, message reception, and an alarm made in the second electronic device.

When the second communication connection for the Internet service is provided, as illustrated in FIGS. 4 and 5, the first electronic device and the second electronic device release the first communication connection for the screen sharing service.

When the second communication connection for the Internet service is provided, as illustrated in FIGS. 4 and 5, the first electronic device and the second electronic device transmit/receive a control signal for the second communication connection using the first communication connection.

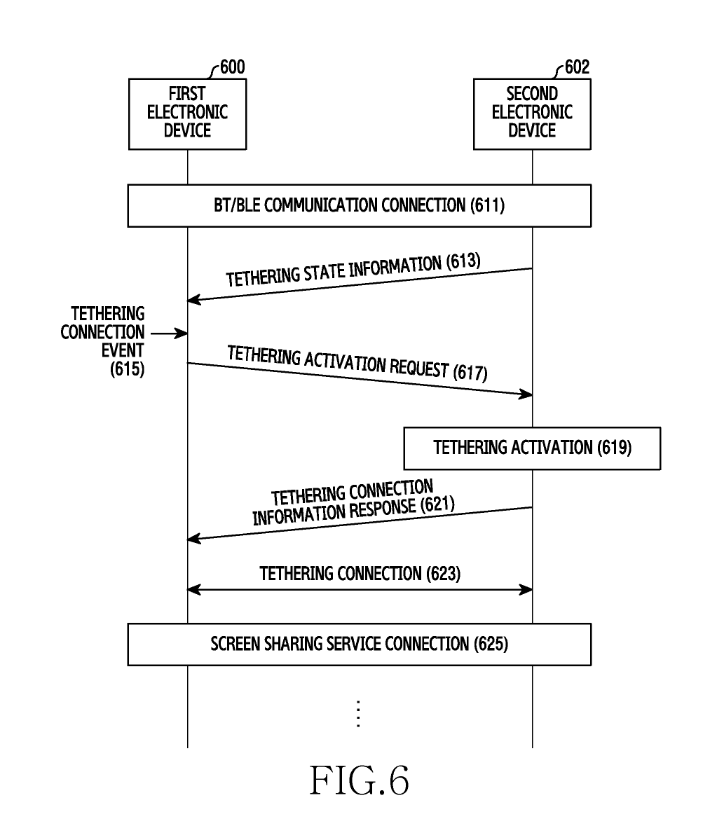

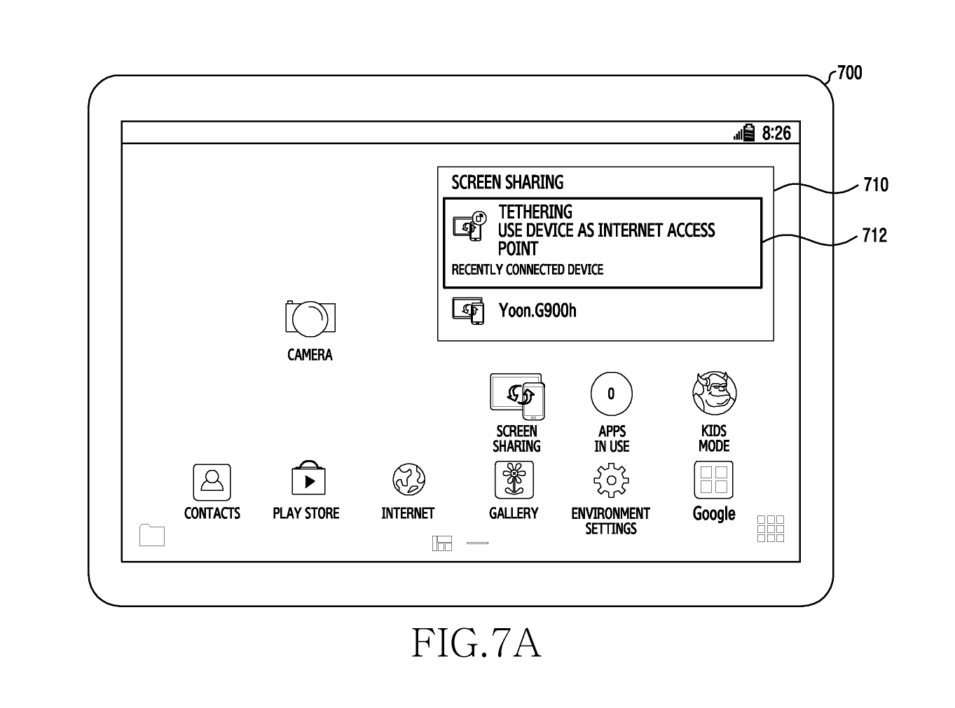

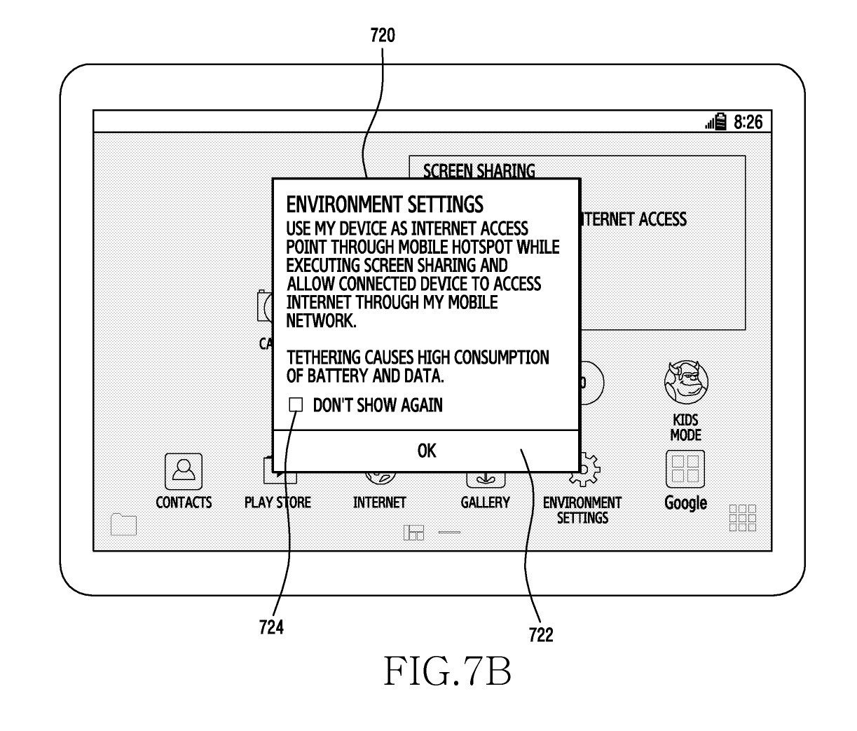

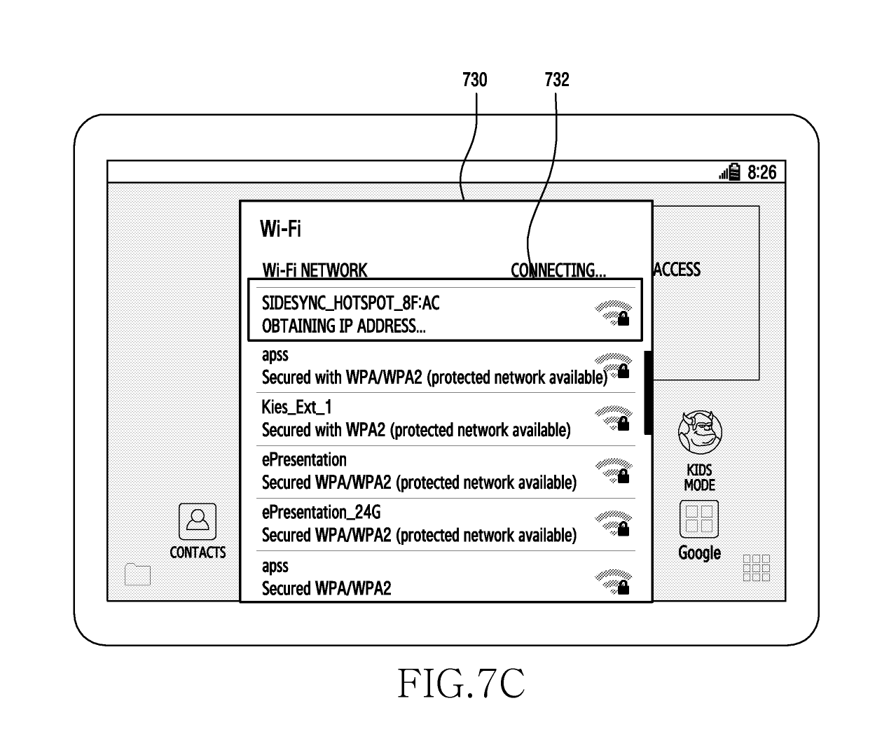

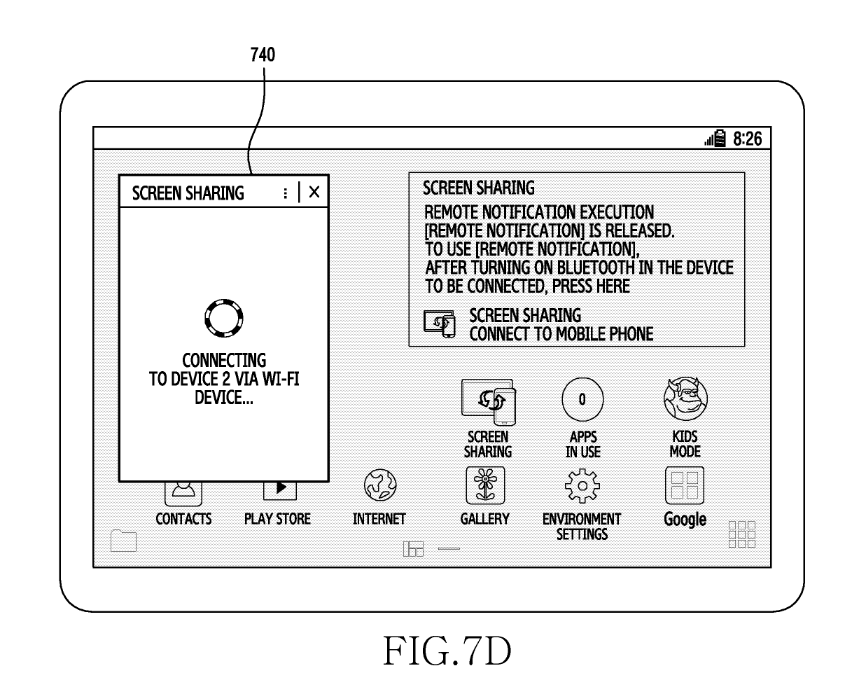

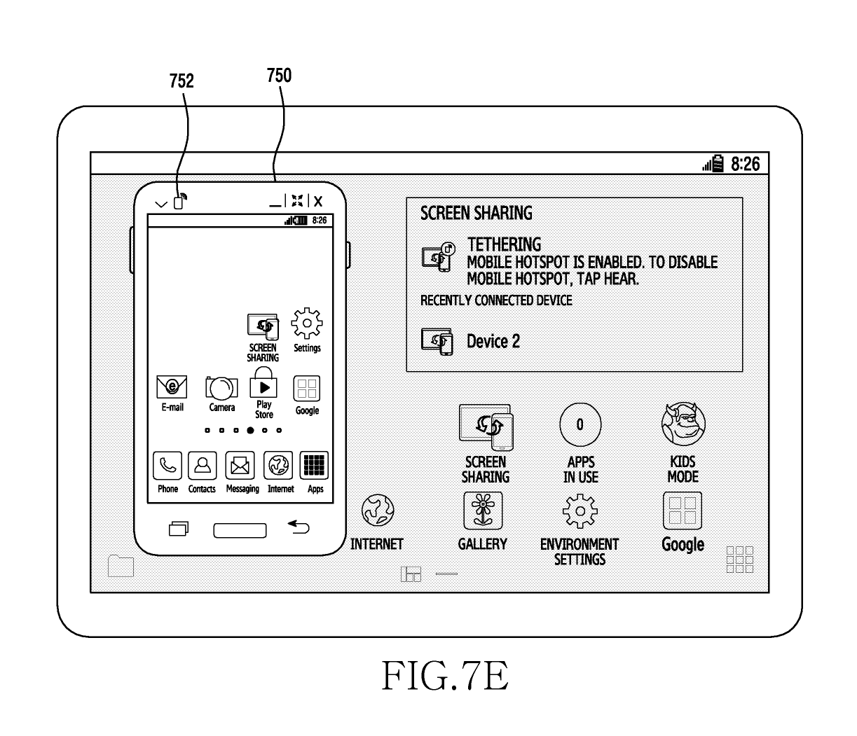

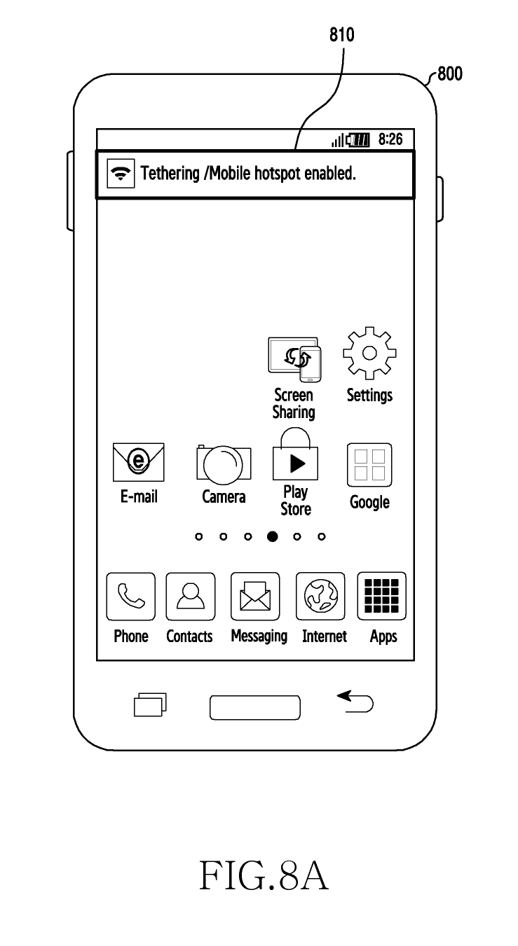

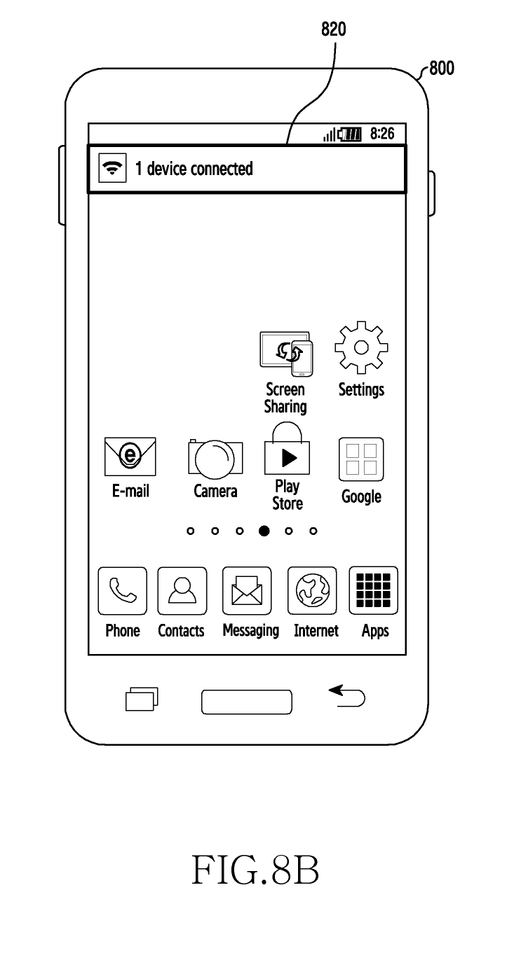

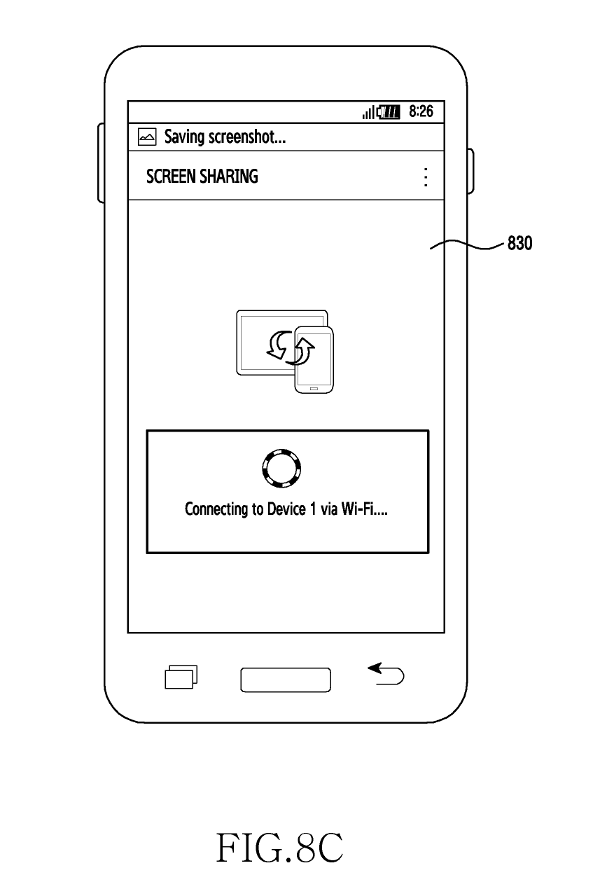

FIG. 6 is a signaling diagram illustrating a tethering connection using a Bluetooth®/BLE communication connection, according to an embodiment of the present disclosure. The following description is based on the signaling diagram for the tethering connection through screen configurations of the first electronic device as illustrated in FIGS. 7A-7E and screen configurations of the second electronic device as illustrated in FIGS. 8A-8C. Hereinafter, the tethering connection may refer to a communication connection for the tethering service.

Referring to FIG. 6, a first electronic device 600 and a second electronic device 602 may have a first communication connection therebetween through Bluetooth® or BLE.

The second electronic device 602 transmits tethering state information to the first electronic device 600 through the first communication connection, as indicated by reference numeral 613. For example, the second electronic device 602 transmits information on whether the second electronic device 602 supports tethering to the first electronic device 600. For example, the second electronic device 602 transmits, to the first electronic device 600, a parameter indicating whether the second electronic device 602 supports the tethering. The parameter may include mobile network accessible information and mobile data use menu set information.

The first electronic device 600 identifies whether the second electronic device 602 supports the tethering based on the tethering state information received through the first communication connection. The first electronic device 600 displays information on whether the second electronic device 602 supports the tethering on the display. The first electronic device 600 (for example, a tablet) displays a widget 710 for the screen sharing service (for example, mirroring service) in at least some areas of a display 700 as illustrated in FIG. 7A. When the second electronic device 602 supports the tethering, the first electronic device 600 may display tethering state information 712 on the second electronic device 602 in the widget 710 for the screen sharing service.

When a tethering connection event is generated as indicated by reference numeral 615, the first electronic device 600 transmits a tethering activation request signal to the second electronic device 602 through the first communication connection. When the tethering connection event is generated based on input information detected through the input/output interface 150, the first electronic device 600 displays a notice 720 according to execution of the tethering on the display 700) as illustrated in FIG. 7B. When the first electronic device 600 detects an input of an “OK” button area 722 through the input/output interface 150, the first electronic device 600 transmits the tethering activation request signal to the second electronic device 602 through the first communication connection. In addition, the first electronic device 600 displays a limit menu 724 for limiting the displaying of a notice 720 in at least some areas of the notice 720 according to execution of the tethering. When the limit menu 724 is set, the first electronic device 600 limits the displaying of the notice 720 according to execution of the tethering.

The second electronic device 602 activates the tethering function in response to reception of the tethering activation request signal as indicated by reference numeral 619. The second electronic device 602 transmits service connection information for the tethering connection and the screen sharing service connection to the first electronic device 600 through the first communication connection in response to the tethering activation request signal as indicated by reference numeral 621. The second electronic device 602 displays tethering function activation information and transmission state information on service connection information 810 in at least some areas (for example, a state display area) of a display 800 as illustrated in FIG. 8A. For example, the second electronic device 602 operates through tethering (for example, AP) by using information for the tethering connection included in service connection information.

The first electronic device 600 and the second electronic device 602 communicate with each other (for example, via WiFi®) for the tethering service using the information for the tethering connection included in the service connection information. The first electronic device 600 searches for one or more APs by activating a wireless LAN module for the tethering connection and displays the found APs, as indicated by reference numeral 730 in FIG. 7C. The first electronic device 600 accesses an AP 732 (hotspot) of the second electronic device 602 from among the one or more APs by using information for the tethering connection. The second electronic device 602 displays hotspot access information 820 of the first electronic device 600 in at least some areas of the display 800 as illustrated in FIG. 8B.

The first electronic device 600 and the second electronic device 602 may connect the screen sharing service through a communication connection for the tethering service as indicated by reference numeral 625. For example, the first electronic device 600 and the second electronic device 602 may generate a channel (for example, a channel of communication for the tethering service) for the screen sharing service by using the access information on the screen sharing service included in the service connection information. The first electronic device 600 displays a screen sharing window 740 for controlling the second electronic device 602 in at least some areas of the display 700, as illustrated in FIG. 7D. The first electronic device 600 displays screen sharing service connection state information (for example, connecting to device) with the second electronic device 602 in the screen sharing window 740. When the screen sharing service with the second electronic device 602 is connected, the first electronic device 600 displays a control screen 750 of the second electronic device 602 in the screen sharing window 740, as illustrated in FIG. 7E. The first electronic device 600 displays an indication indicating the connection of the screen sharing service through the tethering connection in at least some areas of the screen sharing window 740. The second electronic device 602 displays screen sharing service connection state information (for example, connecting to device) 830 between the first electronic device 600 and the second electronic device 602 on the display 800, as illustrated in FIG. 8C. For example, when the screen sharing service with the first electronic device 600 is connected, the second electronic device 602 deactivates the display 800. For example, when the screen sharing service with the first electronic device 600 is connected, the second electronic device 602 displays previous service provision information (for example, a standby screen and a UI of a service, which is being provided) on the display 800. In this case, the second electronic device 602 displays screen sharing service connection information in at least some areas (state display area) of the display 800.

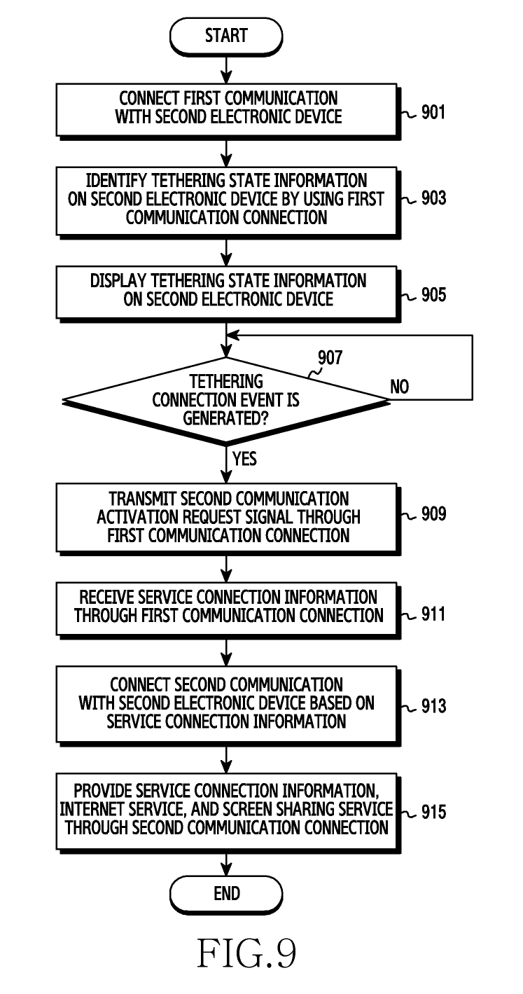

FIG. 9 is a flowchart illustrating a method in which the first electronic device provides tethering by using a Bluetooth®/BLE communication connection, according to an embodiment of the present disclosure. Hereinafter, an operation in which the first electronic device 600 of FIG. 6 provides the tethering with the second electronic device 602 will be described.

Referring to FIG. 9, in operation 901, the first electronic device (for example, the electronic device 100 of FIG. 1) may communicate (for example, Bluetooth® or BLE) with the second electronic device. For example, the first electronic device may connect first communication with the second electronic device.

In operation 903, the first electronic device identifies tethering state information between the first electronic device and the second electronic device using the first communication connection. For example, the first electronic device receives information on whether the second electronic device supports the tethering through the first communication connection. For example, the first electronic device identifies whether the second electronic device supports the tethering by using a parameter, which identifies whether tethering can be supported, received from the second electronic device through the first communication connection. For example, when the second electronic device can be connected to a mobile network through the cellular module (for example, the cellular module 221) and a mobile data use menu is activated, the first electronic device determines that the second electronic device supports the tethering.

In operation 905, the first electronic device displays tethering state information on the second electronic device on the display. For example, when the second electronic device supports the tethering, the first electronic device displays the tethering state information on the second electronic device on the display, as illustrated in FIG. 7A.

In operation 907, the first electronic device detects whether a tethering connection event is generated. For example, when the first electronic device detects selection of the tethering state information on the second electronic device (for example, the tethering state information 712 of FIG. 7A) displayed through the input/output interface 150, the first electronic device determines that the tethering connection event is generated.

When the tethering connection event is not generated in operation 907, the first electronic device again identifies whether the tethering connection event is generated.

When the tethering connection event is generated, the first electronic device transmits a tethering activation request signal to the second electronic device through the first communication connection in operation 909. For example, when the tethering connection event is generated, the first electronic device displays the notice 720 according to execution of the tethering on the display 700 (for example, the display 160), as illustrated in FIG. 7B.

In operation 911, the first electronic device receives service connection information from the second electronic device through the first communication connection in response to the tethering activation request signal. For example, the service connection information may include information for the second communication connection (for example, an identifier of the second electronic device (SSID) and an access password) and access information on the screen sharing service (for example, a MAC address or an IP address).

In operation 913, the first electronic device provides the tethering (second communication connection) to the second electronic device by using the information for the tethering connection included in the service connection information. For example, the first electronic device releases the first communication connection with the second electronic device in response to the tethering connection with the second electronic device.

In operation 915, the first electronic device provides the Internet service and the screen sharing service using the tethering connection with the second electronic device. For example, the first electronic device generates a channel (for example, a logical channel) for the screen sharing service with the second electronic device through the tethering connection with the second electronic device using the access information on the screen sharing service included in the service connection information. The first electronic device provides the screen sharing service with the second electronic device through the channel for the screen sharing service. For example, the first electronic device displays a service screen for the screen sharing service with the second electronic device on the display, as illustrated in FIG. 7E.

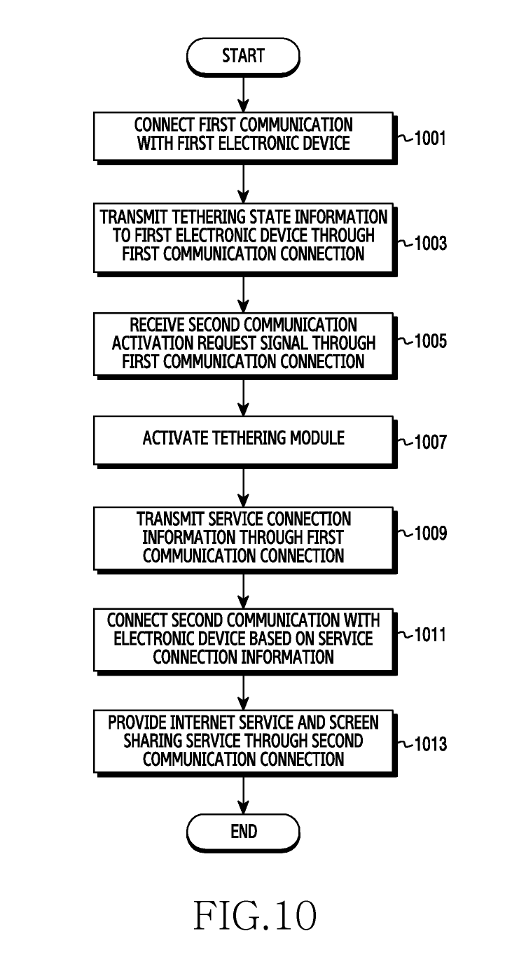

FIG. 10 is a flowchart illustrating a method in which the second electronic device provides tethering by using a Bluetooth®/BLE communication connection, according to an embodiment of the present disclosure. Hereinafter, an operation in which the second electronic device 602 of FIG. 6 provides the tethering with the first electronic device 600 will be described.

Referring to FIG. 10, in operation 1001, the second electronic device communicates (for example, Bluetooth or BLE) with the first electronic device. For example, the second electronic device connects the first communication with the first electronic device.

In operation 1003, the first electronic device identifies tethering state information between the first electronic device and the second electronic device using the first communication connection.

In operation 1005, the second electronic device receives a tethering activation request signal from the first electronic device through the first communication connection.

In operation 1007, the second electronic device activates the tethering function. For example, the second electronic device operates through tethering (for example, AP) using information for the tethering connection, which is included in the service connection information, to be transmitted to the first electronic device.

In operation 1009, the second electronic device transmits the service connection information for the tethering connection and the screen sharing service connection to the first electronic device through the first communication connection in response to the tethering activation request signal.

In operation 1001, the second electronic device provides the tethering (second communication connection) to the first electronic device using the information for the tethering connection included in the service connection information. For example, the second electronic device releases the first communication connection with the first electronic device in response to the tethering connection with the first electronic device.

In operation 1003, the second electronic device provides the Internet service and the screen sharing service using the tethering connection with the first electronic device. For example, the second electronic device generates a channel (for example, a logical channel) for the screen sharing service with the first electronic device through the tethering connection with the first electronic device using the access information on the screen sharing service included in the service connection information. The second electronic device provides the screen sharing service with the first electronic device through the channel for the screen sharing service.

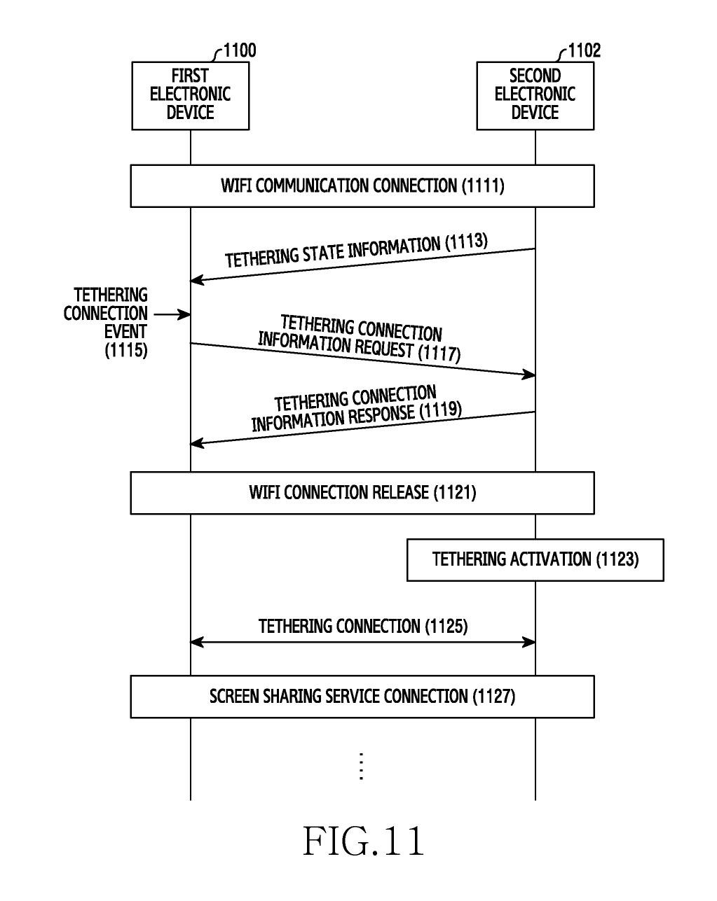

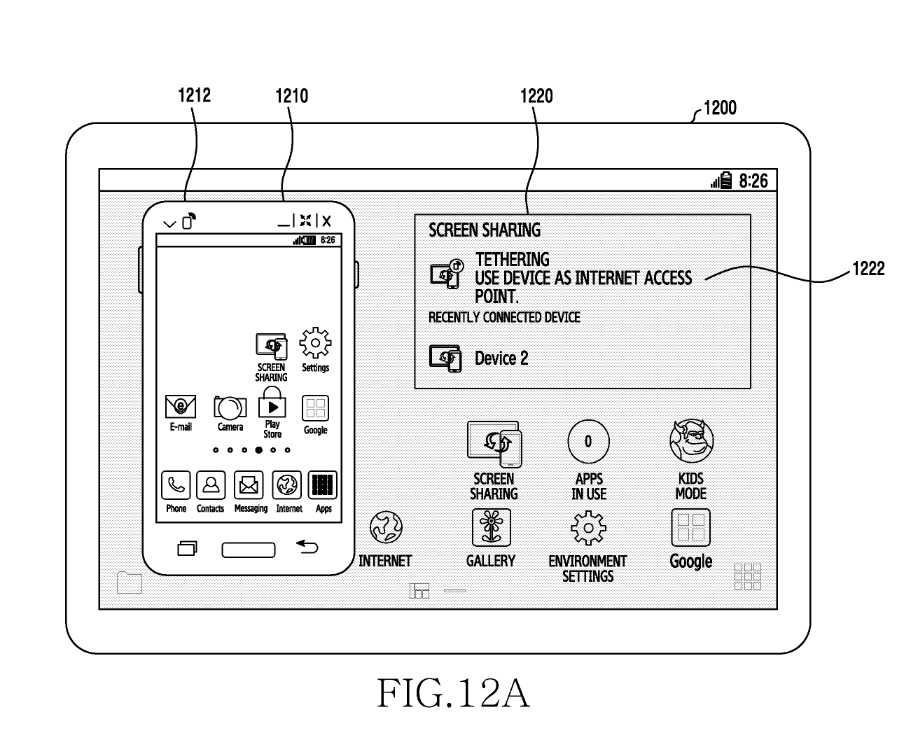

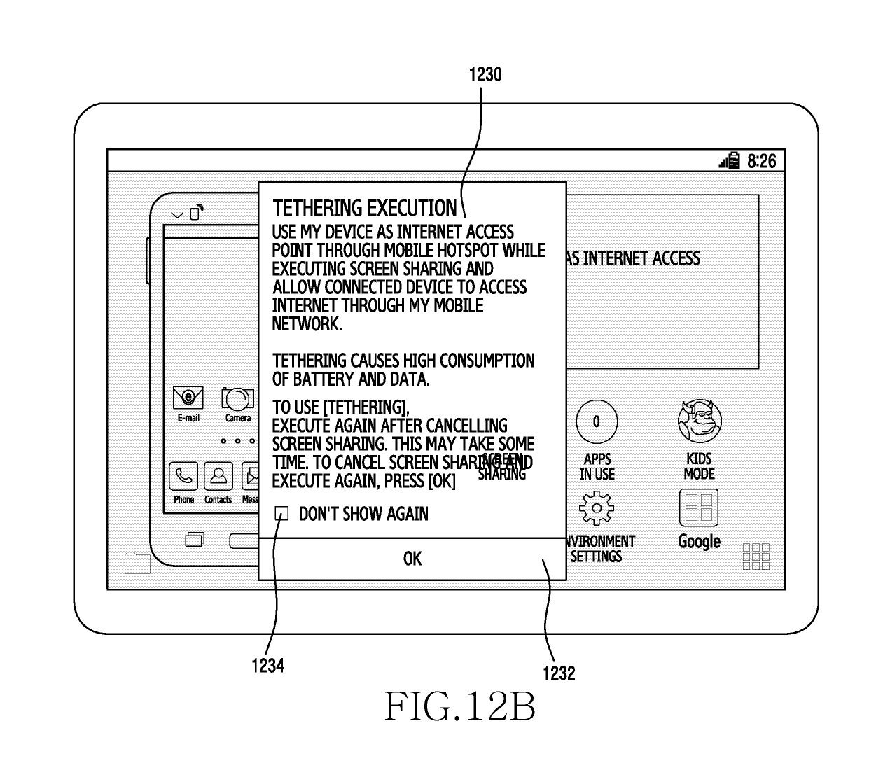

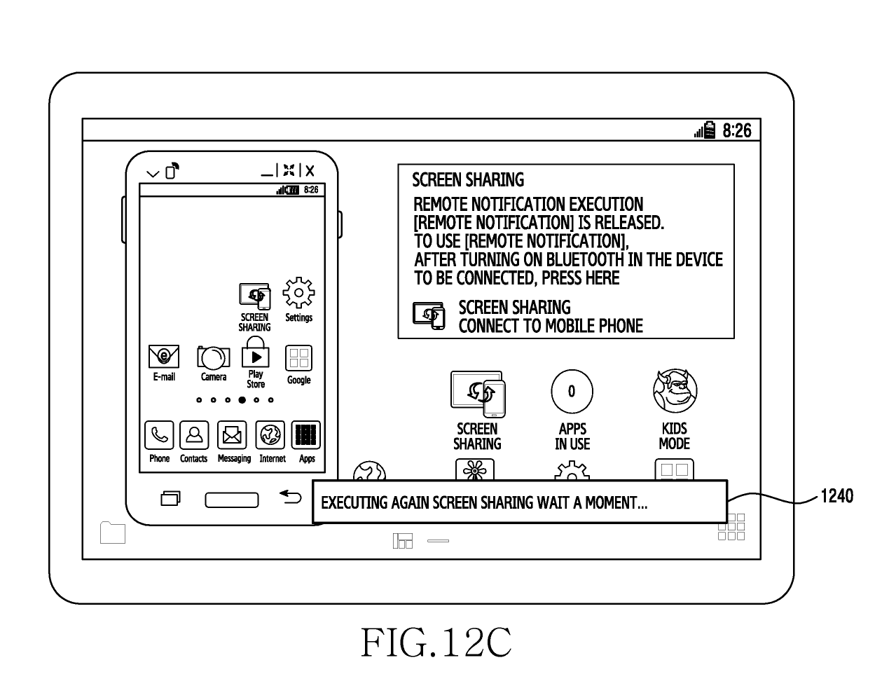

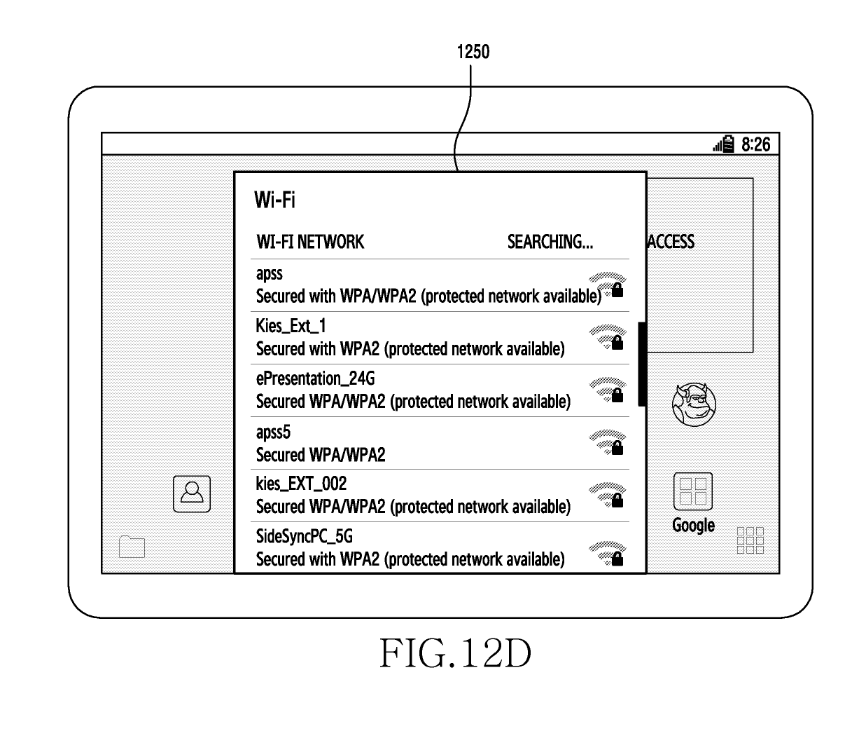

FIG. 11 is a signaling diagram illustrating a tethering connection using a wireless LAN communication connection, according to an embodiment of the present disclosure. Hereinafter, a signaling diagram for the tethering connection will be described using screen configurations of the first electronic device with reference to FIG. 7C and FIGS. 12A-12D.

Referring to FIG. 11, a first electronic device 1100 and a second electronic device 1102 have first communication connection therebetween through WiFi® direct or WiFi® AP, as indicated by reference numeral 1111. For example, the first electronic device 1100 and the second electronic device 1102 may provide a screen sharing service through the first communication connection.

The second electronic device 1102 transmits tethering state information to the first electronic device 1100 through a first communication connection, as indicated by reference numeral 1113.

The first electronic device 1100 identifies whether the second electronic device 1102 supports the tethering based on the tethering state information received through the first communication connection. The first electronic device 1100 (for example, the processor 120) displays information on whether the second electronic device 1102 supports the tethering on the display 160. The first electronic device 1100 (for example, a tablet) displays a widget 1220 for the screen sharing service (for example, mirroring service) in at least some areas of a display 1200 (for example, the display 160), as illustrated in FIG. 12A. When the second electronic device 1102 supports the tethering, the first electronic device 1100 displays tethering state information 1222 on the second electronic device 1102 in the widget 1220 for the screen sharing service. When the screen sharing service with the second electronic device 1102 is connected, the first electronic device 1100 displays a screen sharing window 1210 for controlling the second electronic device 1102 in at least some areas of the display 1200, as illustrated in FIG. 12A. When the second electronic device 1102 supports the tethering, the first electronic device 1100 displays tethering state information 1212 on the second electronic device 1102 in at least a part of the screen sharing window 1210.

When a tethering connection event is generated, as indicated by reference numeral 1115, the first electronic device 1100 transmits a tethering connection information request signal to the second electronic device 1102 through the first communication connection, as indicated by reference numeral 1117. When the tethering connection event is generated based on input information detected through the input/output interface 150, the first electronic device 1100 displays a notice 1230 according to execution of the tethering on the display 1200, as illustrated in FIG. 12B. When the first electronic device 1100 detects an input of an “OK” button area 1232 through the input/output interface 150, the first electronic device 1100 transmits the tethering connection information request signal to the second electronic device 1102 through the first communication connection. In addition, the first electronic device 1100 displays a limit menu 1234 for limiting the displaying of the notice 1230 in at least some areas of the notice 1230, according to execution of the tethering. When the limit menu 1234 is set, the first electronic device 1100 limits the displaying of the notice 1230 according to execution of the tethering.

The second electronic device 1102 transmits service connection information for the tethering connection and the screen sharing service connection to the first electronic device 1100 through the first communication connection in response to the tethering connection information request signal, as indicated by reference numeral 1119.

The first electronic device 1100 and the second electronic device 1102 release the first communication connection for the tethering connection, as indicated by reference numeral 1121. For example, the first electronic device 1100 transmits a response signal (for example, an ACK signal) for the service connection information to the second electronic device 1102. After transmitting the response signal for the service connection information, the first electronic device 1100 releases the first communication connection with the second electronic device 1102. When the second electronic device 1102 receives the response signal for the service connection information, the second electronic device 1102 releases the first communication connection with the first electronic device 1100. The first electronic device 1100 displays the release of the first communication connection with the second electronic device 1102 on the display 1200 (for example, the display 160) for the tethering connection, as illustrated in FIG. 12C.

After releasing the first communication connection with the first electronic device 1100, the second electronic device 1102 activates the tethering function for the second communication connection with the first electronic device 1100. For example, the second electronic device 1102 operates through tethering (for example, AP) using information for the tethering connection included in service connection information.

The first electronic device 1100 and the second electronic device 1102 may provide communication (for example, WiFi) for the tethering service using the information for the tethering connection included in the service connection information, as indicated by reference numeral 1125. The first electronic device 1100 searches for one or more APs by activating a wireless LAN module for the tethering connection and displays the found APs on the display 1200, as indicated by reference numeral 1250 in FIG. 12D. When the first electronic device 1100 finds the AP 732 (hotspot) of the second electronic device 1102 using the information for the tethering connection, as illustrated in FIG. 7C, the first electronic device 1100 accesses the AP of the second electronic device 1102.

The first electronic device 1100 and the second electronic device 1102 provide the screen sharing service through a tethering connection, as indicated by reference numeral 1127. For example, the first electronic device 1100 and the second electronic device 1102 generate a channel (for example, a logical channel of communication for the tethering service) for the screen sharing service using the access information on the screen sharing service included in the service connection information. The first electronic device 1100 and the second electronic device 1102 transmit/receive data for the screen sharing service through the channel for the screen sharing service.

Each of the first electronic device 1100 and the second electronic device 1102 performs a wireless LAN connection for the screen sharing service or a wireless LAN connection for the tethering using one wireless LAN module (for example, the WiFi® module 223). Accordingly, for the wireless LAN connection for the tethering, the first electronic device 1100 and the second electronic device 1102 release the wireless LAN connection for the screen sharing service and then connect the wireless LAN again based on the information for the tethering connection. Hereinafter, an operation in which the first electronic device 1100 of FIG. 11 provides the tethering to the second electronic device 1102 will be described.

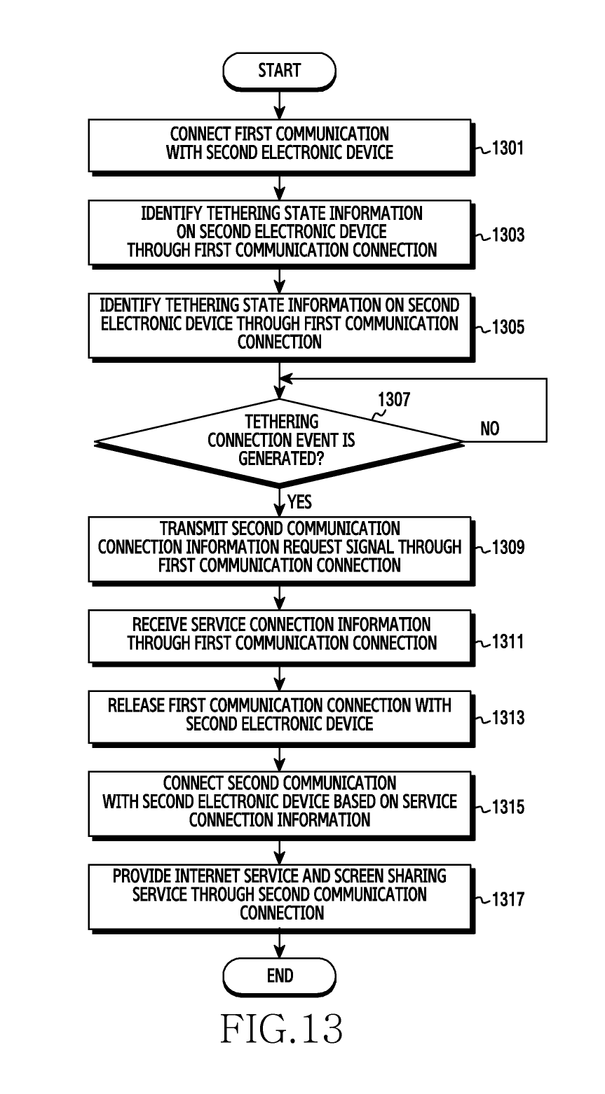

FIG. 13 is a flowchart illustrating a method in which the first electronic device provides tethering by using a wireless LAN communication connection, according to an embodiment of the present disclosure.

Referring to FIG. 13, in operation 1301, the first electronic device (for example, the electronic device 100 of FIG. 1) communicates (for example, WiFi® direct or WiFi® AP) with the second electronic device. For example, the first electronic device provides a screen sharing service with the second electronic device through a first communication connection.

In operation 1303, the first electronic device identifies tethering state information on the second electronic device using the first communication connection. For example, the first electronic device receives information on whether the second electronic device supports the tethering through the first communication connection.

In operation 1305, the first electronic device displays tethering state information on the second electronic device on the display. For example, when the second electronic device supports the tethering, the first electronic device displays the tethering state information on the second electronic device on the display, as illustrated in FIG. 12A.

In operation 1307, the first electronic device identifies whether a tethering connection event is generated. For example, when the first electronic device detects selection of the tethering state information on the second electronic device (for example, the tethering state information 1212 or 1222 of FIG. 12A) displayed on the display through the input/output interface 150, the first electronic device determines that the tethering connection event is generated.

When the tethering connection event is not generated in operation 1307, the first electronic device again identifies whether the tethering connection event is generated.

When the tethering connection event is generated, the first electronic device transmits a tethering connection information request signal to the second electronic device through the first communication connection in operation 1309. For example, when the tethering connection event is generated, the first electronic device displays the notice 1230 according to execution of the tethering on the display 1200, as illustrated in FIG. 12B.

In operation 1311, the first electronic device receives service connection information from the second electronic device through the first communication connection in response to the tethering connection information request signal.

In operation 1313, for the tethering connection, the first electronic device releases the first communication connection (wireless LAN connection) with the second electronic device.

In operation 1315, the first electronic device connects the tethering (second communication) with the second electronic device using the information for the tethering connection included in the service connection information.

In operation 1317, the first electronic device provides the Internet service and the screen sharing service using the tethering connection with the second electronic device. For example, the first electronic device generates a logical channel of the second communication for the screen sharing service with the second electronic device through the tethering connection with the second electronic device using the access information on the screen sharing service included in the service connection information. The first electronic device provides the screen sharing service with the second electronic device through the channel for the screen sharing service.

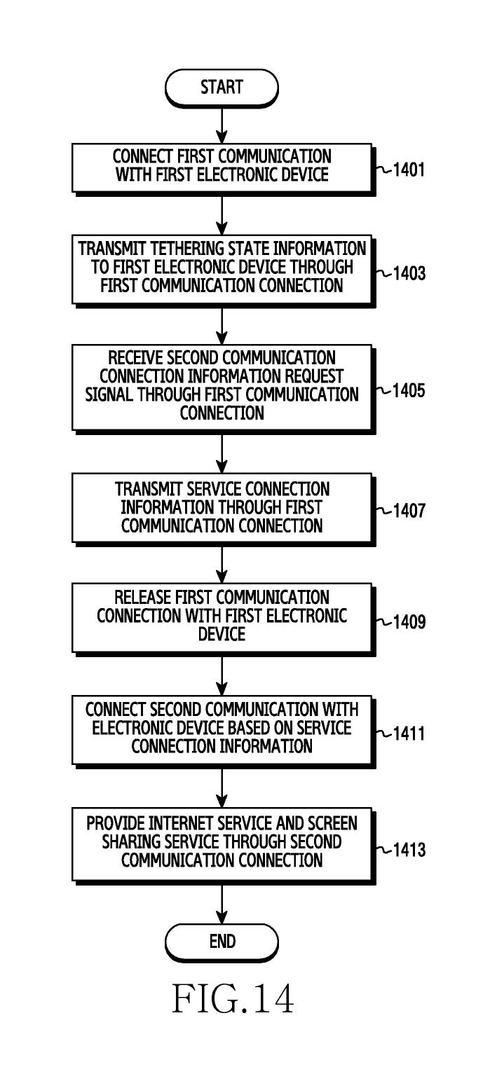

FIG. 14 is a flowchart illustrating a method in which the second electronic device provides tethering by using a wireless LAN communication connection, according to an embodiment of the present disclosure. Hereinafter, an operation in which the second electronic device 1102 of FIG. 11 provides the tethering with the first electronic device 1100 will be described.

Referring to FIG. 14, in operation 1401, the second electronic device (for example, the electronic device 100 of FIG. 1) communicates (for example, WiFi® direct or WiFi® AP) with the first electronic device. For example, the second electronic device provides a screen sharing service with the first electronic device through a first communication connection.

In operation 1403, the second electronic device transmits tethering state information on the second electronic device to the first electronic device through the first communication connection.

In operation 1405, the second electronic device receives a tethering connection information request signal from the first electronic device through the first communication connection.

In operation 1407, the second electronic device transmits the service connection information for the tethering connection and the screen sharing service connection to the first electronic device through the first communication connection in response to the tethering connection information request signal.

In operation 1409, for the tethering connection, the second electronic device releases the first communication connection (wireless LAN connection) with the first electronic device.

In operation 1411, the second electronic device connects the tethering (second communication) with the first electronic device using the information for the tethering connection included in the service connection information.

In operation 1413, the second electronic device provides the Internet service and the screen sharing service using the tethering connection with the first electronic device. For example, the second electronic device generates a logical channel of the second communication for the screen sharing service with the first electronic device through the tethering connection with the first electronic device using the access information on the screen sharing service included in the service connection information. The second electronic device provides the screen sharing service with the first electronic device through the channel for the screen sharing service.

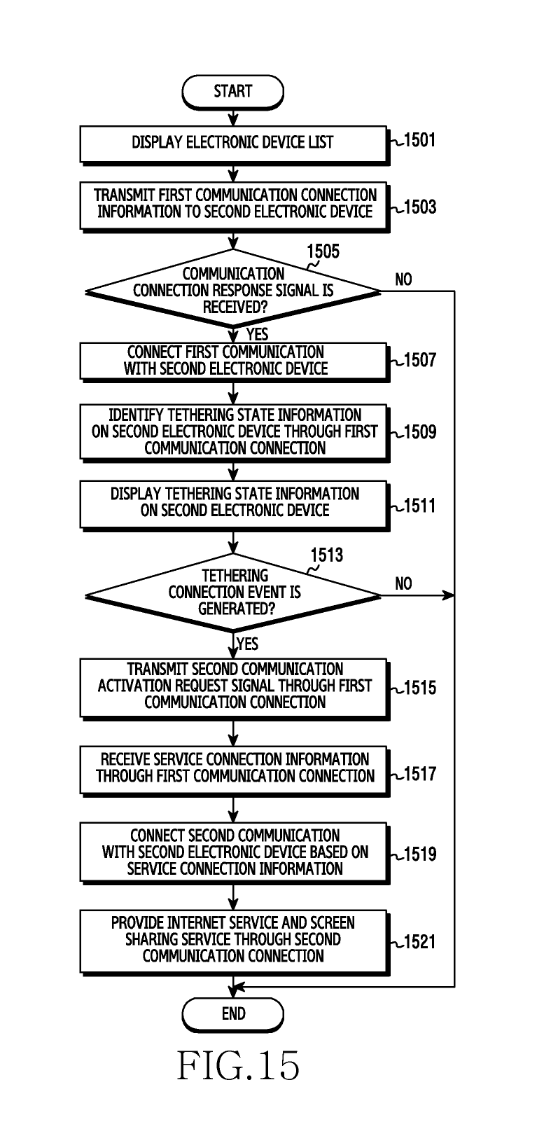

FIG. 15 is a flowchart illustrating a method in which the first electronic device provides tethering by using a Bluetooth®/BLE communication connection with the second electronic device, according to an embodiment of the present disclosure.

Referring to FIG. 15, in operation 1501, the first electronic device (for example, the electronic device 100) displays a list of communication connectable electronic devices on the display. For example, the first electronic device displays a list of one or more other electronic devices, to which the first electronic device has provided the screen sharing service, on the display.

In operation 1503, the first electronic device transmits first communication connection request information to the second electronic device included in the electronic device list. For example, the first electronic device transmits the first communication connection request information to the second electronic device selected by input information detected through the input/output interface 150 among the one or more electronic devices included in the electronic device list.

In operation 1505, the first electronic device identifies whether a response signal of the first communication connection request information is received from the second electronic device.

When the first electronic device does not receive the response signal of the first communication connection request information from the second electronic device, the first electronic device recognizes that the communication with the second electronic device cannot be connected.

When the first electronic device receives the response signal of the first communication connection request information from the second electronic device, the first electronic device connects first communication (for example, Bluetooth® or BLE) with the second electronic device in operation 1507.

In operation 1509, the first electronic device identifies tethering state information on the second electronic device using the first communication connection. For example, the first electronic device receives information on whether the second electronic device supports the tethering through the first communication connection.

In operation 1511, the first electronic device displays tethering state information on the second electronic device on the display. For example, the first electronic device displays the tethering state information on the second electronic device on the display, as illustrated in FIG. 7A.

In operation 1513, the first electronic device identifies whether a tethering connection event is generated.

When the tethering connection event is not generated in operation 1513, the first electronic device again identifies whether the tethering connection event is generated.

When the tethering connection event is generated, the first electronic device transmits a tethering activation request signal to the second electronic device through the first communication connection in operation 1515.

In operation 1517, the first electronic device receives service connection information from the second electronic device through the first communication connection in response to the tethering activation request signal.

In operation 1519, the first electronic device provides the tethering (second communication connection) to the second electronic device using the information for the tethering connection included in the service connection information. For example, the first electronic device releases the first communication connection with the second electronic device in response to the tethering connection with the second electronic device.

In operation 1521, the first electronic device provides the Internet service and the screen sharing service using the tethering connection with the second electronic device. For example, the first electronic device generates a channel for the screen sharing service with the second electronic device through the tethering connection with the second electronic device using the access information on the screen sharing service included in the service connection information. The first electronic device transmits/receives data for the screen sharing service to/from the second electronic device through the channel for the screen sharing service.

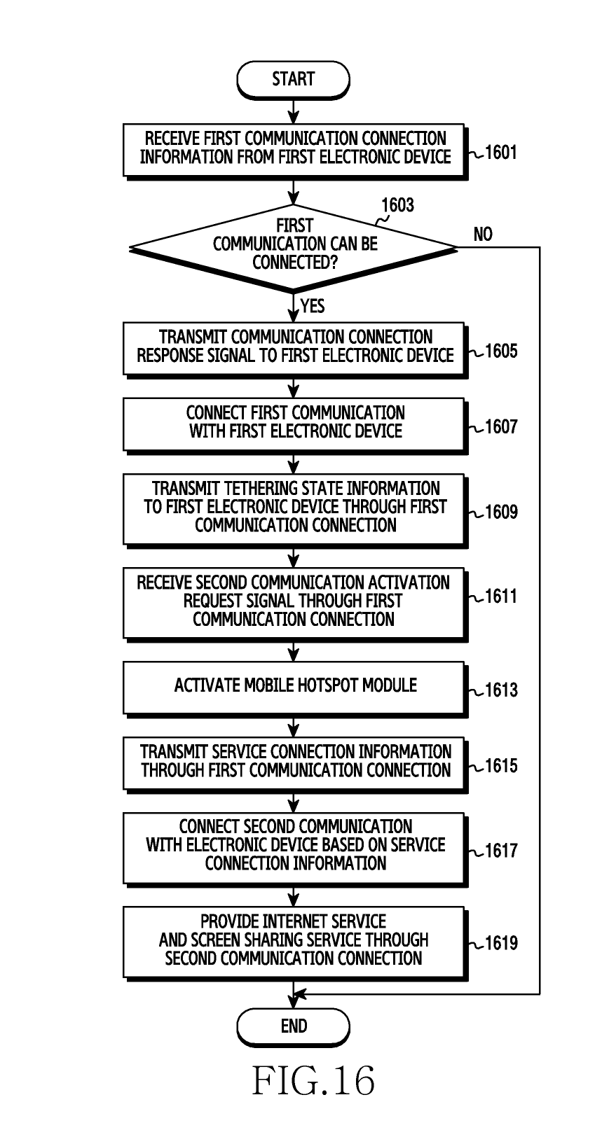

FIG. 16 is a flowchart illustrating a method in which the second electronic device provides tethering by using a Bluetooth®/BLE communication connection with the first electronic device, according to an embodiment of the present disclosure.

Referring to FIG. 16, in operation 1601, the second electronic device (for example, the electronic device 100) receives first communication connection request information from the first electronic device.

In operation 1603, the second electronic device identifies whether first communication with the first electronic device can be connected. For example, the second electronic device identifies the first communication connection with the first electronic device in consideration of a load and a signal intensity of a first communication network.

When the second electronic device determines that the first communication connection with the first electronic device cannot be obtained, the second electronic device may end the algorithm.

When the second electronic device determines that the first communication connection with the first electronic device cannot be obtained, the second electronic device transmits response information on the first communication connection request information to the first electronic device in operation 1605.

In operation 1607, the second electronic device communicates (for example, Bluetooth® or BLE) with the first electronic device.

In operation 1609, the second electronic device transmits tethering state information on the second electronic device to the first electronic device through the first communication connection.

In operation 1611, the second electronic device receives a tethering activation request signal from the first electronic device through the first communication connection.

In operation 1613, the second electronic device activates the tethering function. For example, the second electronic device operates through tethering (for example, AP) using information for the tethering connection, which is included in the service connection information, to be transmitted to the first electronic device.

In operation 1615, the second electronic device transmits the service connection information for the tethering connection and the screen sharing service connection to the first electronic device through the first communication connection in response to the tethering activation request signal.

In operation 1617, the second electronic device provides the tethering (second communication connection) to the first electronic device using the information for the tethering connection included in the service connection information.

In operation 1619, the second electronic device provides the Internet service and the screen sharing service using the tethering connection with the first electronic device. For example, the second electronic device generates a channel for the screen sharing service with the first electronic device through the tethering connection with the first electronic device using the access information on the screen sharing service included in the service connection information. The second electronic device transmits/receives data for the screen sharing service to/from the first electronic device through the channel for the screen sharing service.

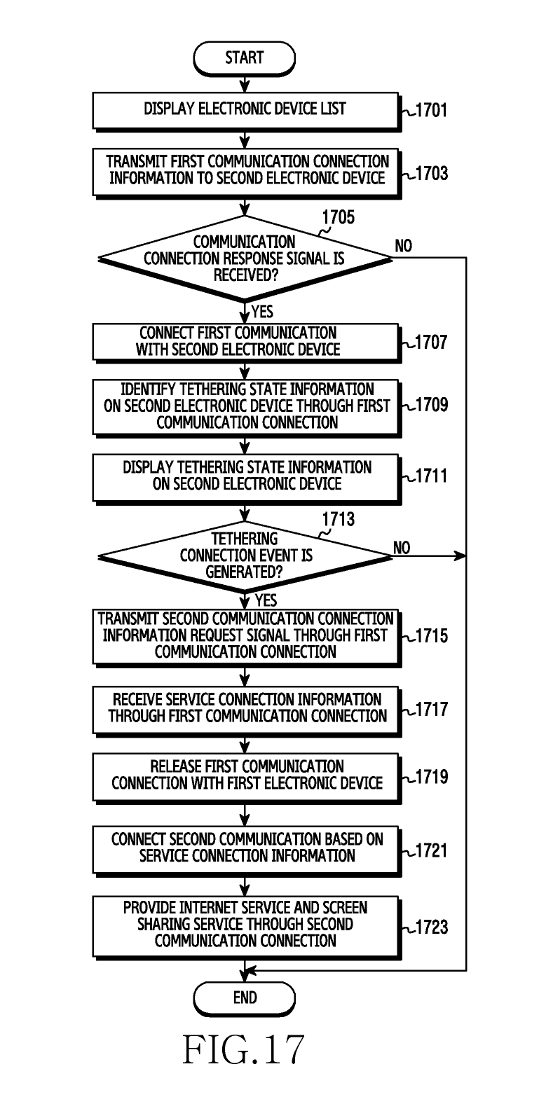

FIG. 17 is a flowchart illustrating a method in which the first electronic device provides tethering by using a wireless LAN communication connection with the second electronic device, according to an embodiment of the present disclosure.

Referring to FIG. 17, in operation 1701, the first electronic device (for example, the electronic device 100) displays a list of communication connectable electronic devices on the display. For example, the first electronic device displays a list of one or more other electronic devices to which the first electronic device has provided the screen sharing service.

In operation 1703, the first electronic device transmits first communication connection request information to the second electronic device included in the electronic device list.

In operation 1705, the first electronic device identifies whether a response signal of the first communication connection request information is received from the second electronic device.

When the first electronic device does not receive the response signal of the first communication connection request information from the second electronic device, the first electronic device recognizes that the communication with the second electronic device cannot be obtained.

When the first electronic device receives the response signal of the first communication connection request information from the second electronic device, the first electronic device communicates (for example, WiFi® direct or WiFi® AP) with the second electronic device in operation 1707. For example, the first electronic device provides a screen sharing service with the second electronic device through a first communication connection.

In operation 1709, the first electronic device identifies tethering state information on the second electronic device using the first communication connection. For example, the first electronic device receives information on whether the second electronic device supports the tethering through the first communication connection.

In operation 1711, the first electronic device displays tethering state information on the second electronic device on the display. For example, the first electronic device displays the tethering state information on the second electronic device on the display.

In operation 1713, the first electronic device identifies whether a tethering connection event is generated.

The first electronic device may end the algorithm when the tethering connection event is not generated.

When the tethering connection event is generated, the first electronic device transmits a tethering connection information request signal to the second electronic device through the first communication connection in operation 1715.

In operation 1717, the first electronic device receives service connection information from the second electronic device through the first communication connection in response to the tethering connection information request signal.

In operation 1719, for the tethering connection, the first electronic device releases the first communication connection (wireless LAN connection) from the second electronic device.

In operation 1721, the first electronic device provides the tethering (second communication connection) with the second electronic device using the information for the tethering connection included in the service connection information.

In operation 1723, the first electronic device provides the Internet service and the screen sharing service using the tethering connection with the second electronic device. For example, the first electronic device generates a channel for the screen sharing service with the second electronic device through the tethering connection with the second electronic device using the access information on the screen sharing service included in the service connection information. The first electronic device transmits/receives data for the screen sharing service to/from the second electronic device through the channel for the screen sharing service.

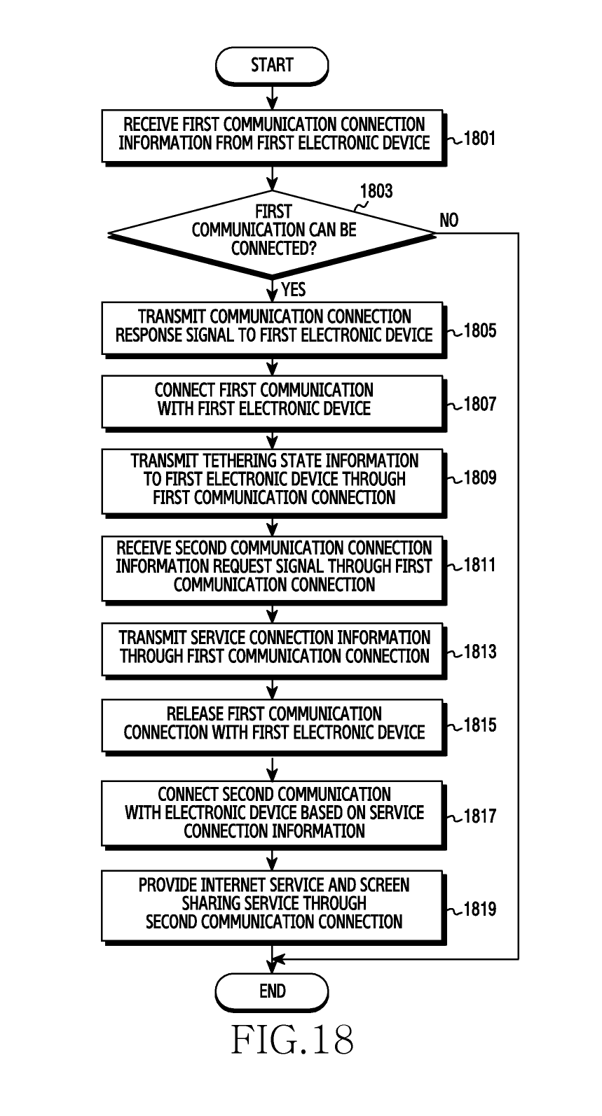

FIG. 18 is a flowchart illustrating a method in which the second electronic device provides tethering by using a wireless LAN communication connection with the first electronic device, according to an embodiment of the present disclosure.

Referring to FIG. 18, in operation 1801, the second electronic device receives first communication connection request information from the first electronic device.

In operation 1803, the second electronic device identifies whether first communication connection with the first electronic device can be obtained.

When the second electronic device determines that the first communication with the first electronic device cannot be connected, the second electronic device may end the algorithm.

When the second electronic device determines that the first communication connection with the first electronic device cannot be obtained, the second electronic device transmits response information on the first communication connection request information to the first electronic device in operation 1805.

In operation 1807, the second electronic device communicates (for example, WiFi® direct or WiFi® AP) with the first electronic device. For example, the second electronic device provides a screen sharing service with the first electronic device through a first communication connection.

In operation 1809, the second electronic device transmits tethering state information on the second electronic device to the first electronic device through the first communication connection.

In operation 1811, the second electronic device receives a tethering connection information request signal from the first electronic device through the first communication connection.

In operation 1813, the second electronic device transmits the service connection information for the tethering connection and the screen sharing service connection to the first electronic device through the first communication connection in response to the tethering connection information request signal.

In operation 1815, for the tethering connection, the second electronic device releases the first communication connection (wireless LAN connection) with the first electronic device.

In operation 1817, the second electronic device provides the tethering (second communication connection) with the first electronic device using the information for the tethering connection included in the service connection information.

In operation 1819, the second electronic device provides the Internet service and the screen sharing service using the tethering connection with the first electronic device. For example, the second electronic device generates a channel for the screen sharing service with the first electronic device through the tethering connection with the first electronic device using the access information on the screen sharing service included in the service connection information. The second electronic device transmits/receives data for the screen sharing service to/from the first electronic device through the channel for the screen sharing service.

According to various embodiments, when electronic devices provide communication for a tethering service using Bluetooth®/BLE, the electronic devices provide the communication for the tethering after releasing a first communication connection of Bluetooth®/BLE for a screen sharing service as illustrated in FIG. 11.

According to various embodiments, when electronic devices provide communication for a tethering service using Bluetooth®/BLE, the electronic devices provide the communication for the tethering in a state where a first communication connection of wireless LAN for a screen sharing service is maintained, as illustrated in FIG. 6.

According to various embodiments of the present disclosure, a method of operating an electronic device may include: transmitting service connection information to a counterpart electronic device through first communication with the counterpart electronic device; connecting second communication with the counterpart electronic device based on the service connection information; and transmitting/receiving data corresponding to an Internet service and a screen sharing service of the counterpart electronic device through the second communication.

According to various embodiments, the first communication may include at least one of Bluetooth, Bluetooth Low Energy (BLE), WiFi direct, and WiFi Access Point (AP).

According to various embodiments, the second communication may include a communication scheme for tethering.

According to various embodiments, the communication scheme for the tethering service may include a wireless LAN.

According to various embodiments, the service connection information may include information for the second communication connection and access information on the screen sharing service.

According to various embodiments, the connecting of the second communication may include: releasing the first communication connection with the counterpart electronic device when the first communication is a wireless LAN; and connecting the second communication with the counterpart electronic device by using the service connection information.

According to various embodiments, the transmitting/receiving of the data may include: generating a channel of the second communication for the screen sharing service with the counterpart electronic device based on the service request information; and transmitting/receiving data corresponding to the Internet service and the screen sharing service of the counterpart electronic device through the channel.

According to various embodiments, the method may further include: transmitting second communication scheme supporting information to the counterpart electronic device through the first communication; and identifying whether a second communication connection request signal is received from the counterpart electronic device through the first communication, wherein the transmitting of the service connection information to the counterpart electronic device may include transmitting the service connection information to the counterpart electronic device through the first communication when the second communication connection request signal is received from the counterpart electronic device.

According to various embodiments, the second communication scheme supporting information may be determined by whether the electronic device supports a mobile network and mobile data transmission/reception set menu information of the electronic device.

According to various embodiments of the present disclosure, a method of operating an electronic device may include: receiving service connection information from a counterpart electronic device through first communication with the counterpart electronic device; connecting second communication with the counterpart electronic device based on the service connection information; and transmitting/receiving data corresponding to an Internet service and a screen sharing service through the second communication.

According to various embodiments, the first communication may include at least one of Bluetooth, Bluetooth Low Energy (BLE), WiFi direct, and WiFi Access Point (AP).

According to various embodiments, the second communication may include a communication scheme for a tethering service.

According to various embodiments, the communication scheme for the tethering service may include a wireless LAN.

According to various embodiments, the service connection information may include information for the second communication connection and access information on the screen sharing service.

According to various embodiments, the connecting of the second communication may include: releasing the first communication connection with the counterpart electronic device when the first communication is a wireless LAN; and connecting the second communication with the counterpart electronic device by using the service connection information.

According to various embodiments, the transmitting/receiving of the data may include: generating a channel of the second communication for the screen sharing service with the counterpart electronic device based on the service request information; and transmitting/receiving data corresponding to the Internet service and the screen sharing service through the channel.

According to various embodiments, the method may further include: receiving supporting information on a second communication scheme from the counterpart electronic device through the first communication; and displaying the supporting information on the second communication scheme of the counterpart electronic device.

According to various embodiments, the method may further include: detecting input information for the display supporting information on the second communication scheme; and transmitting a second communication connection request signal to the counterpart electronic device through the first communication.

According to various embodiments of the present disclosure, a method of operating an electronic device may include: transmitting/receiving screen sharing data through an established connection with an external device according to a first communication scheme; receiving a request for activating a second communication scheme which can be provided by a communication module for the first communication scheme; activating the second communication scheme in response to the request; and establishing another connection with the external device according to the second communication scheme.

In accordance with the present disclosure, a non-transitory computer-readable recording medium having a program recorded therein to execute a process is provided. The process includes: transmitting service connection information to a counterpart electronic device through first communication with the counterpart electronic device; connecting second communication with the counterpart electronic device based on the service connection information; and transmitting/receiving data corresponding to an Internet service and a screen sharing service of the counterpart electronic device through the second communication.

An electronic device and a method according to embodiments of the present disclosure may provide a screen sharing service (for example, a mirroring service) and an Internet service through, for example, one communication connection (for example, WiFi®), thereby increasing usability of the screen sharing service and the Internet service.

At least some of the devices (for example, modules or functions thereof) or the method (for example, operations) according to the present disclosure may be implemented by a command stored in a non-transitory computer-readable storage medium in a programming module form. The instruction, when executed by a processor (e.g., the processor 120), may cause the one or more processors to execute the function corresponding to the instruction. The non-transitory computer-readable storage medium may be, for example, the memory 130.

The computer readable recording medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements may be executed sequentially, in parallel, repeatedly, or in a heuristic manner. Further, some operations may be executed according to another order or may be omitted, or other operations may be added. Further, the embodiments disclosed herein are only for the description and understanding of technical contents and do not limit the scope of the present disclosure. Accordingly, the scope of the present disclosure should be construed as including all modifications or various other embodiments based on the technical idea of the present disclosure.

While the present disclosure has been shown and described with reference to certain embodiments thereof, it should be understood by those skilled in the art that many variations and modifications of the method and apparatus described herein will still fall within the spirit and scope of the present disclosure as defined in the appended claims and their equivalents.

What is claimed is:

1. A method of operating an electronic device, the method comprising:
transmitting service connection information to another electronic device through a first communication connection;
connecting, via a second communication connection, with the other electronic device based on the service connection information; and
transmitting/receiving data corresponding to an Internet service and a screen sharing service of the another electronic device through the second communication connection.

2. The method of claim 1, wherein the first communication connection includes at least one of Bluetooth®, Bluetooth Low Energy (BLE), WiFi® direct, and WiFi® Access Point (AP).

3. The method of claim 1, wherein the second communication connection includes a communication scheme for a tethering service.

4. The method of claim 3, wherein the communication scheme for tethering includes a wireless Local Area Network (LAN).

5. The method of claim 1, wherein the service connection information includes information for the second communication connection and access information on the screen sharing service.

6. The method of claim 1, wherein connecting via the second communication connection comprises:
releasing the first communication connection with the another electronic device when the first communication connection is a wireless LAN; and
providing the second communication connection with the another electronic device by using the service connection information.

7. The method of claim 1, wherein transmitting/receiving the data comprises:
generating a channel of the second communication connection for the screen sharing service with the another electronic device based on the service request information; and
transmitting/receiving data corresponding to the Internet service and the screen sharing service of the another electronic device through the generated channel.

8. The method of claim 1, further comprising:
transmitting second communication scheme supporting information to the another electronic device through the first communication connection; and
identifying whether a second communication connection request signal is received from the another electronic device through the first communication connection,
wherein transmitting the service connection information to the another electronic device comprises transmitting the service connection information to the another electronic device through the first communication connection when the second communication connection request signal is received from the another electronic device.

9. The method of claim 8, wherein the second communication scheme supporting information is determined based on whether the electronic device supports a mobile network and mobile data transmission/reception set menu information of the electronic device.

10. A method of operating an electronic device, the method comprising:
receiving service connection information from another electronic device through a first communication connection;
connecting, via a second communication connection, with the other electronic device based on the service connection information; and
transmitting/receiving data corresponding to an Internet service and a screen sharing service through the second communication connection.

11. An electronic device comprising:
a communication interface configured to connect the electronic device with another electronic device by using a plurality of communication schemes; and
a processor configured to provide an Internet service and a screen sharing service to the another electronic device,
wherein the processor is configured to transmit service connection information to the another electronic device through a first communication connection, to connect, via a second communication connection, with the another electronic device based on the service connection information, and to transmit/receive data corresponding to the Internet service and the screen sharing service of the another electronic device through the second communication connection.

12. The electronic device of claim 11, wherein the first communication connection includes at least one of Bluetooth®, Bluetooth® Low Energy (BLE), WiFi® direct, and WiFi® Access Point (AP).

13. The electronic device of claim 11, wherein the second communication connection includes a communication scheme for a tethering service.

14. The electronic device of claim 13, wherein the communication scheme for the tethering service includes a wireless Local Area Network (LAN).

15. The electronic device of claim 11, wherein the service connection information includes information for the second communication connection and access information on the screen sharing service.

16. The electronic device of claim 11, wherein the processor is further configured to release the first communication connection with the another electronic device when the first communication connection is a wireless LAN and to provide the second communication connection with the another electronic device by using the service connection information.

17. The electronic device of claim 11, wherein the processor is further configured to generate a channel of the second communication connection for the screen sharing service with the another electronic device based on the service request information and to transmit/receive data corresponding to the Internet service and the screen sharing service of the another electronic device through the generated channel.

18. The electronic device of claim 11, wherein the processor is further configured to transmit second communication scheme supporting information to the another electronic device through the first communication connection and to transmit service connection information to the another electronic device through the first communication connection when a second communication connection request signal is received from the another electronic device.

19. The electronic device of claim 18, wherein the processor is further configured to determine the second communication scheme supporting information of the another electronic device based on whether the electronic device supports a mobile network and mobile data transmission/reception set menu information of the electronic device.

20. An electronic device comprising:
a communication interface configured to connect the electronic device with another electronic device by using a plurality of communication schemes; and
a processor configured to provide an Internet service and a screen sharing service to the another electronic device,
wherein the processor is configured to receive service connection information from the another electronic device through a first communication connection with the another electronic device, to connect, via a second communication connection, with the another electronic device based on the service connection information, and to transmit/receive data corresponding to the Internet service and the screen sharing service through the second communication connection.
